(19) United States
(12) Patent Application Publication
(10) Pub. No.: US 2026/0023292 A1
(43) Pub. Date: Jan. 22, 2026

(54) DISPLAY PANEL AND DISPLAY APPARATUS

(71) Applicants: CHENGDU BOE DISPLAY SCI-TECH CO., LTD., Sichuan (CN); BOE Technology Group Co., Ltd., Beijing (CN)

(72) Inventors: Cong ZHANG, Beijing (CN); Guidong YANG, Beijing (CN); Toshifumi YAGI, Beijing (CN); Jiajin LIU, Beijing (CN); Yuanhui GUO, Beijing (CN); Yue GUAN, Beijing (CN); Honghui PENG, Beijing (CN); Lei LIU, Beijing (CN); Junying XIAO, Beijing (CN)

(21) Appl. No.: 18/996,416

(22) PCT Filed: May 15, 2024
(86) PCT No.: PCT/CN2024/093451

§ 371 Date: Jan. 17, 2025

(30) Foreign Application Priority Data
Jun. 14, 2023 (CN) 202310702904.8

(51) Int. Cl. G02F 1/1362

(52) U.S. Cl. CPC G02F 1/136286

(57) ABSTRACT

A display panel and a display apparatus. The display panel comprises: an array substrate and an opposite substrate, which are arranged opposite each other; a plurality of data lines, which are located on the array substrate and extend in a first direction; a plurality of pixel electrodes, which are located on the array substrate, wherein at least one of the plurality of pixel electrodes comprises a plurality of sub-pixel electrode portions arranged in the first direction; a first electrode, which is located on the array substrate, wherein the first electrode comprises a plurality of first hollowed-out portions; and a common electrode, which is located on the opposite substrate.

### CROSS-REFERENCES TO RELATED APPLICATIONS

The present disclosure is a National Stage of International Application No. PCT/CN2024/093451, filed on May 15, 2024, which claims priority to Chinese patent application No. 202310702904.8 filed to China National Intellectual Property Administration on Jun. 14, 2023, the entire contents of which are incorporated herein by reference.

### TECHNICAL FIELD

The present disclosure relates to the field of semiconductor technology, and in particular to a display panel and a display device.

### BACKGROUND

Photo-alignment technology (UV2A) derives its name from the multiplication of ultraviolet (UV) light and the VA method of LCD panels, which can precisely manipulate the alignment of liquid crystal molecules through UV light and greatly improve the light transmittance. The key to UV2A is the use of special polymer materials as the alignment film, which can control the tilting of liquid crystal molecules along the direction of ultraviolet light with high precision. The accuracy is measured in picometers (one trillionth of a meter). The advantage of UV2A is that the liquid crystal panel is a simple structure without protrusions or slits. This “liquid crystal technician's dream” was discussed 30 years ago. Now, with the three conditions of new materials, production equipment, and perfect processing, this dream has been realized. The simple structure of LCD panels not only improves productivity, but also has many advantages in terms of image quality.

Super ultra fine vertical alignment (SUVA) is an upgraded version of UV2A compared to compared to UV2A pixel design, and SUVA pixel design has better response time and color shift characteristics than UV2A pixel design.

### SUMMARY

The present disclosure provides a display panel and a display device. The display panel includes: an array substrate and an opposite substrate arranged opposite to each other; a plurality of data lines, located in the array substrate, and extending along a first direction; a plurality of pixel electrodes, located in the array substrate, where at least one pixel electrode of the plurality of pixel electrodes includes a plurality of sub-pixel electrode portions arranged along the first direction; a first electrode, located in the array substrate, where the first electrode includes a plurality of first hollow portions, an orthographic projection of the first hollow portions on the array substrate is within an orthographic projection of the sub-pixel electrode portions on the array substrate; and a common electrode, located in the opposite substrate.

In a possible implementation, the first electrode is on a side of the pixel electrode facing away from the opposite substrate.

In a possible implementation, the first electrode is loaded with the same signal as the common electrode.

In a possible implementation, the plurality of sub-pixel electrode portions includes: two sub-pixel electrode groups distributed along the first direction, the sub-pixel electrode group includes two of the sub-pixel electrode portions, the sub-pixel electrode portion is provided with a plurality of slit structures extending along the same direction, and the slit structures of the two sub-pixel electrode portions which are adjacent to each other and are included in the sub-pixel electrode group extend in different directions.

In a possible implementation, an axis line extending along a direction perpendicular to the first direction is between two sub-pixel electrode portions of one sub-pixel electrode group; and two first hollow portions corresponding to the one sub-pixel electrode group are symmetrical with respect to the axis line.

In a possible implementation, a region of a center of an orthographic projection of the first hollow portion on the array substrate coincides with a region of a center of an orthographic projection of the sub-pixel electrode portion on the array substrate.

In a possible implementation, the orthographic projection of the first hollow portion on the array substrate is a circle or an ellipse.

In a possible implementation, the orthographic projection of the first hollow portion on the array substrate is a rectangle, and at least one edge of the rectangle is parallel to an outer edge of the sub-pixel electrode portion.

In a possible implementation, the first hollow portion includes a first edge extending along the first direction; and extension lines of the first edges of two first hollow portions corresponding to one sub-pixel electrode group coincide with each other.

In a possible implementation, the extension line of at least one of the first edges of the first hollow portions corresponding to one of two sub-pixel electrode groups in one pixel electrode does not coincide with the extension line of at least one of the first edges of the first hollow portions corresponding to another of the two sub-pixel electrode groups in the one pixel electrode.

In a possible implementation, the orthographic projection of the first hollow portion on the array substrate is a hexagon, and at least one edge of the hexagon is parallel to an outer edge of the sub-pixel electrode portion.

In a possible implementation, the at least one edge of the hexagon is parallel to an extension direction of the slit structures of the sub-pixel electrode portion in which the hexagon is located.

In a possible implementation, at least one edge of the hexagon is perpendicular to an extension direction of the slit structures of the sub-pixel electrode portion in which the hexagon is located.

In a possible implementation, an orthographic projection of the first hollow portion on the array substrate is a right-angled trapezoid; where at least one edge of the right-angled trapezoid is parallel to an outer edge of the sub-pixel electrode portion, and a hypotenuse of the right-angled trapezoid crosses an extension direction of the slit structures.

In a possible implementation, a right-angled edge of the right-angled trapezoid extends along the first direction, and the hypotenuse of the right-angled trapezoid is perpendicular to the extension direction of the slit structures.

In a possible implementation, top edges of two first hollow portions of right-angled trapezoids corresponding to one sub-pixel electrode group are provided in close proximity to each other.

In a possible implementation, bottom edges of two first hollow portions of right-angled trapezoids corresponding to one sub-pixel electrode group are provided in close proximity to each other.

In a possible implementation, extension lines of the right-angled edges of two first hollow portions of right-angled trapezoids corresponding to one sub-pixel electrode group coincide with each other.

In a possible implementation, an extension line of the right-angled edge of the first hollow portion of a trapezoid corresponding to one of two sub-pixel electrode groups in one pixel electrode does not coincide with an extension line of the right-angled edge of the first hollow portion of a trapezoid corresponding to another of the two sub-pixel electrode groups in the one pixel electrode.

In a possible implementation, the orthographic projection of the first hollow portion on the array substrate is an X-shape; where the first hollow portion includes: a first hollow sub-portion extending along a third direction, and a second hollow sub-portion extending along a fourth direction, and the first hollow sub-portion crosses the second hollow sub-portion.

In a possible implementation, one of the first hollow sub-portion or the second hollow sub-portion extends in a direction parallel to an extension direction of the slit structures of the sub-pixel electrode portion in which the one of the first hollow sub-portion or the second hollow sub-portion is located, and another of the first hollow sub-portion or the second hollow sub-portion extends in a direction perpendicular to an extension direction of the slit structures of the sub-pixel electrode portion in which the another of the first hollow sub-portion or the second hollow sub-portion is located.

In a possible implementation, two first hollow portions corresponding to one sub-pixel electrode group are a one-piece structure.

In a possible implementation, two first hollow portions corresponding to one sub-pixel electrode group are separated structures.

In a possible implementation, the slit structures are uniformly distributed throughout the sub-pixel electrode portion.

In a possible implementation, the slit structures are distributed in only a partial region of the sub-pixel electrode portion, and the sub-pixel electrode portion further includes a block structure.

In a possible implementation, the block structures in two sub-pixel electrode groups in one pixel electrode are distributed at different positions; and the block structures in two sub-pixel electrode portions of one sub-pixel electrode group are a one-piece structure.

In a possible implementation, an orthographic projection of the first hollow portion on the array substrate is at least partially overlapped with an orthographic projection of the block structure on the array substrate.

In a possible implementation, the plurality of sub-pixel electrode portions include: a first sub-pixel electrode portion, a second sub-pixel electrode portion, a third sub-pixel electrode portion, and a fourth sub-pixel electrode portion arranged sequentially along the first direction; where an extension direction of the slit structures of the first sub-pixel electrode portion is the same as an extension direction of the slit structures of the third sub-pixel electrode portion, and an extension direction of the slit structures of the second sub-pixel electrode portion is the same as an extension direction of the slit structures of the fourth sub-pixel electrode portion.

In a possible implementation, the display panel further includes a plurality of gate lines, located in the array substrate, and extending along a second direction; where an orthographic projection of the gate line on the array substrate has an overlapping region with an orthographic projection of a gap between the second sub-pixel electrode portion and the third sub-pixel electrode portion on the array substrate.

In a possible implementation, the gate line includes a first gate line hollow; where an orthographic projection of the first gate line hollow on the array substrate is overlapped with an orthographic projection of a portion of the data line on the array substrate.

In a possible implementation, the pixel electrode further includes: a connection portion connecting the second sub-pixel electrode portion to the third sub-pixel electrode portion; and the gate line further includes a second gate line hollow, where an orthographic projection of the second gate line hollow on the array substrate is at least partially overlapped with an orthographic projection of the connection portion on the array substrate.

In a possible implementation, extension lines of the connection portions of two pixel electrodes which are adjacent to each other in the first direction do not coincide with each other.

In a possible implementation, the first electrode further includes: a second hollow portion; where an orthographic projection of the second hollow portion on the array substrate covers the orthographic projection of the connection portion on the array substrate.

Embodiments of the present disclosure also provide a display device, including the display panel provided by the embodiments of the present disclosure.

### BRIEF DESCRIPTION OF FIGURES

FIG. 1 is a cross-sectional schematic view of a display panel provided by embodiments of the present disclosure.

FIG. 2A is a first top schematic view of an array substrate provided by embodiments of the present disclosure.

FIG. 2B is a schematic diagram of a single film layer of gate lines in FIG. 2A.

FIG. 2C is a schematic diagram of a single film layer of data lines in FIG. 2A.

FIG. 2D is a schematic diagram of a single film layer of an active layer in FIG. 2A.

FIG. 2E is a schematic diagram of a single film layer of a first insulating layer in FIG. 2A.

FIG. 2F is a schematic diagram of a single film layer of a first electrode in FIG. 2A.

FIG. 2G is a schematic diagram of a single film layer of a second insulating layer in FIG. 2A.

FIG. 2H is a schematic diagram of a single film layer of a pixel electrode of FIG. 2A.

FIG. 2I is a schematic diagram of a black matrix corresponding to FIG. 2A.

FIG. 2J is an optical simulation corresponding to FIG. 2A.

FIG. 3A is a second top schematic view of an array substrate provided by embodiments of the present disclosure.

FIG. 3B is a schematic diagram of a single film layer of a first electrode in FIG. 3A.

FIG. 3C is an optical simulation corresponding to FIG. 3A.

FIG. 4A is a third top schematic view of an array substrate provided by embodiments of the present disclosure.

FIG. 4B is a schematic diagram of a single film layer of a first electrode in FIG. 4A.

FIG. 4C is an optical simulation corresponding to FIG. 4A.

FIG. 5A is a fourth top schematic view of an array substrate provided by embodiments of the present disclosure.

FIG. 5B is a schematic diagram of a single film layer of a first electrode in FIG. 5A.

FIG. 5C is an optical simulation corresponding to FIG. 5A.

FIG. 6A is a fifth top schematic view of an array substrate provided by embodiments of the present disclosure.

FIG. 6B is a schematic diagram of a single film layer of a first electrode in FIG. 6A.

FIG. 6C is a schematic diagram of a single film layer of a pixel electrode in FIG. 6A.

FIG. 6D is an optical simulation corresponding to FIG. 6A.

FIG. 7A is a sixth top schematic view of an array substrate provided by embodiments of the present disclosure.

FIG. 7B is a schematic diagram of a single film layer of a first electrode in FIG. 7A.

FIG. 7C is an optical simulation corresponding to FIG. 7A.

FIG. 8A is a seven top schematic view of an array substrate provided by embodiments of the present disclosure.

FIG. 8B is a schematic diagram of a single film layer of a first electrode in FIG. 8A.

FIG. 8C is an optical simulation corresponding to FIG. 8A.

FIG. 9A is an eight top schematic view of an array substrate provided by embodiments of the present disclosure.

FIG. 9B is a schematic diagram of a single film layer of a first electrode in FIG. 9A.

FIG. 9C is an optical simulation corresponding to FIG. 9A.

FIG. 10A is a ninth top schematic view of an array substrate provided by embodiments of the present disclosure.

FIG. 10B is a schematic diagram of a single film layer of a first electrode in FIG. 10A.

FIG. 10C is an optical simulation corresponding to FIG. 10A.

FIG. 11A is a tenth top schematic view of an array substrate provided by embodiments of the present disclosure.

FIG. 11B is a schematic diagram of a single film layer of a first electrode in FIG. 11A.

FIG. 11C is a schematic diagram of a single film layer of a pixel electrode in FIG. 11A.

FIG. 11D is an optical simulation corresponding to FIG. 11A.

FIG. 12A is an eleventh top schematic view of an array substrate provided by embodiments of the present disclosure.

FIG. 12B is a schematic diagram of a single film layer of gate lines corresponding to FIG. 12A.

FIG. 13A is a twelfth top schematic view of an array substrate provided by embodiments of the present disclosure.

FIG. 13B is a schematic diagram of a single film layer of gate lines corresponding to FIG. 13A.

FIG. 14 is an equivalent circuit diagram provided by embodiments of the present disclosure.

### DETAILED DESCRIPTION

In order to make the objects, technical solutions and advantages of the embodiments of the present disclosure clearer, the technical solutions of the embodiments of the present disclosure will be described clearly and completely in the following in conjunction with the accompanying drawings of the embodiments of the present disclosure. Obviously, the described embodiments are a part of the embodiments of the present disclosure and not all of the embodiments. Based on the described embodiments of the present disclosure, all other embodiments obtained by a person of ordinary skill in the art without the need for creative labor fall within the scope of protection of the present disclosure.

Unless otherwise defined, technical or scientific terms used in the present disclosure shall have the ordinary meaning understood by a person of ordinary skill in the field to which the present disclosure belongs. The terms “first”, “second”, and the like as used in the present disclosure do not indicate any order, number, or significance, but are only used to distinguish different components. The words “including” or “comprising” and the like are intended to mean that the component or object preceded by the word encompasses the component or object listed after the word and its equivalents, and does not exclude other components or objects. Words such as “connected” or “coupled” are not limited to physical or mechanical connections, but may include electrical connections, whether direct or indirect. The words “up”, “down”, “left”, “right”, etc. are used only to indicate relative positional relationships. When the absolute position of the object being described changes, the relative positional relationship may also change accordingly.

As used herein, “about” or “substantially the same” includes the stated value and means within an acceptable range of deviation from the specified value as determined by a person of ordinary skill in the art taking into account the measurements discussed and the errors associated with the measurement of the specified quantity (i.e., the limitations of the measurement system). For example, “substantially the same” may mean that the difference relative to the stated value is within one or more standard deviations, or within a range of ±30%, 20%, 10%, or 5%.

In the accompanying drawings, the thicknesses of layers, films, panels, regions, and the like are enlarged for clarity. Exemplary embodiments are described herein with reference to a cross-sectional view as a schematic diagram of an idealized embodiment. In this way, deviations from the shape of the drawing as a result of, for example, manufacturing techniques and/or tolerances will be expected. Thus, the embodiments described herein should not be interpreted as being limited to the specific shape of the region as shown herein, but rather as including deviations in shape caused by, e.g., manufacturing. For example, regions illustrated or described as flat may typically have rough and/or non-linear features. Furthermore, the sharp corners illustrated may be rounded. Thus, the regions shown in the drawings are schematic in nature and their shapes are not intended to be the precise shapes of the illustrated regions and are not intended to limit the scope of the present claims.

In order to keep the following description of embodiments of the present disclosure clear and concise, the present disclosure omits detailed descriptions of known features and known components.

High resolution products, such as 8K and 16K display products, are the main direction for subsequent products, but the current 8K products of Vertical Alignment liquid crystal (VA) suffer from low transmittance rate, as well as poor color shift.

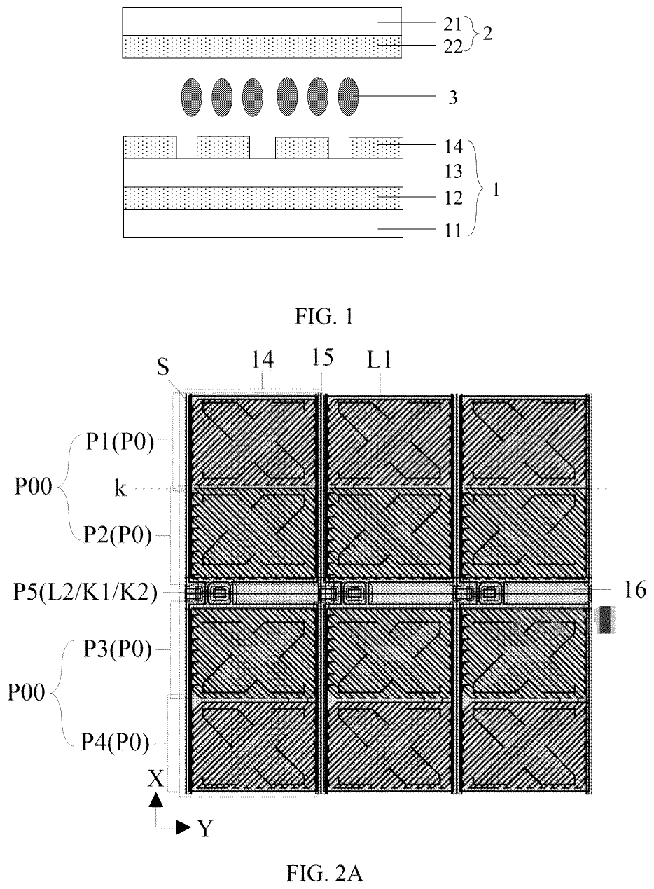

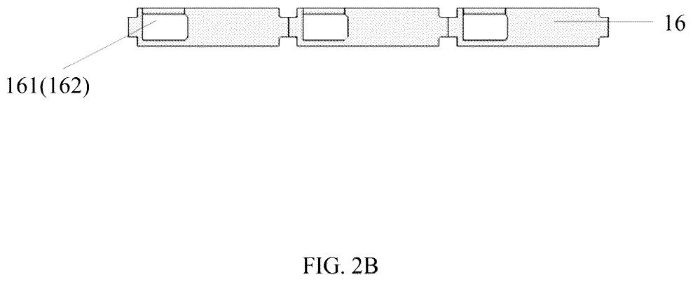

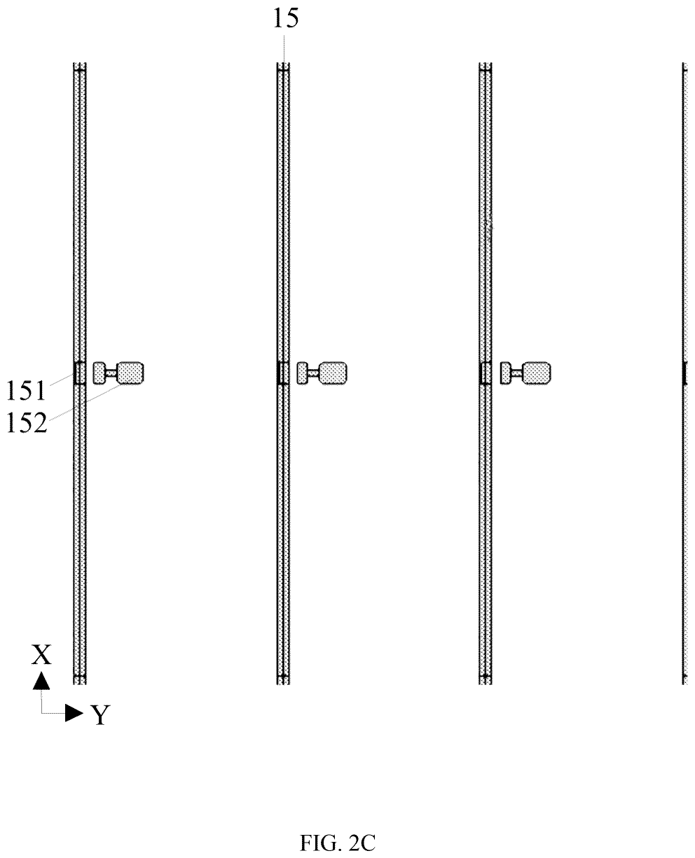

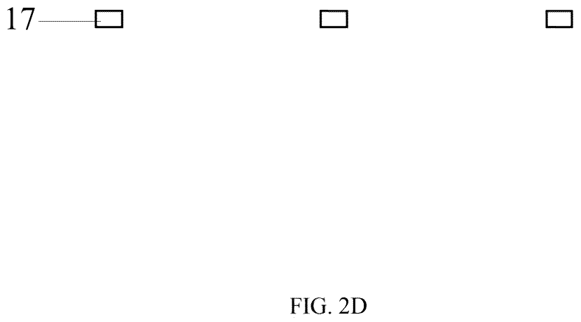

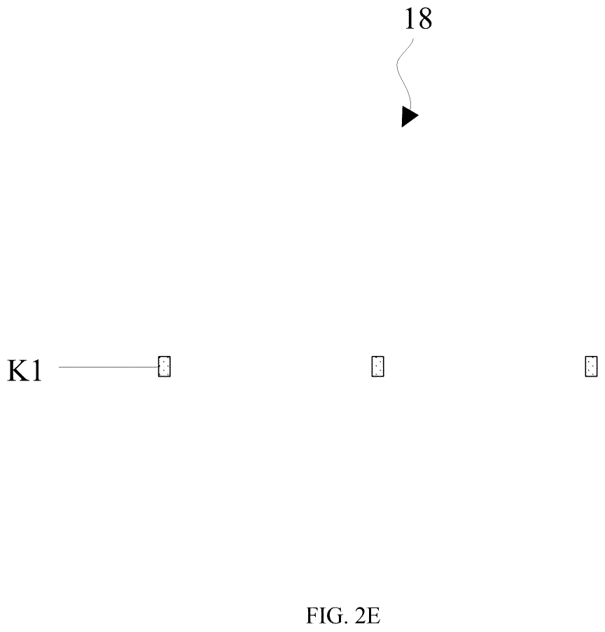

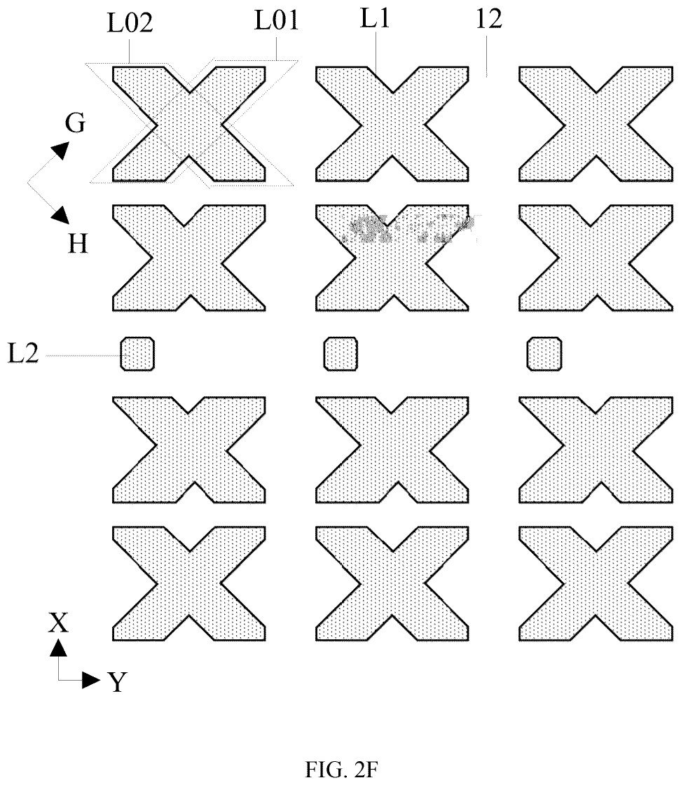

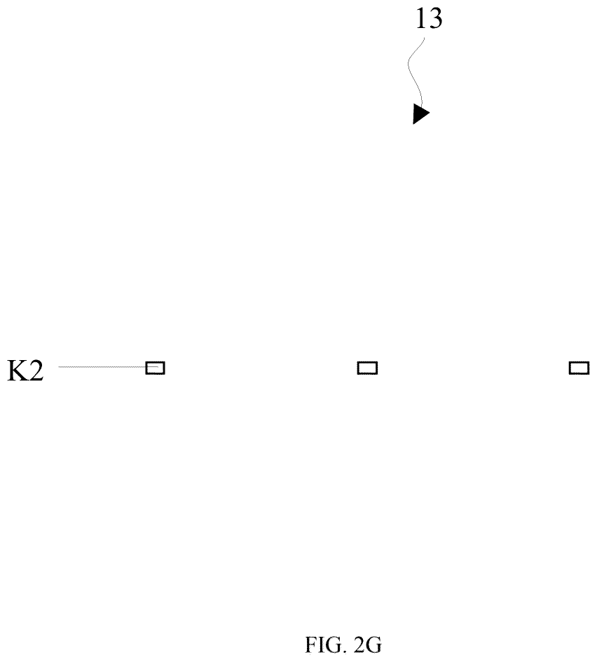

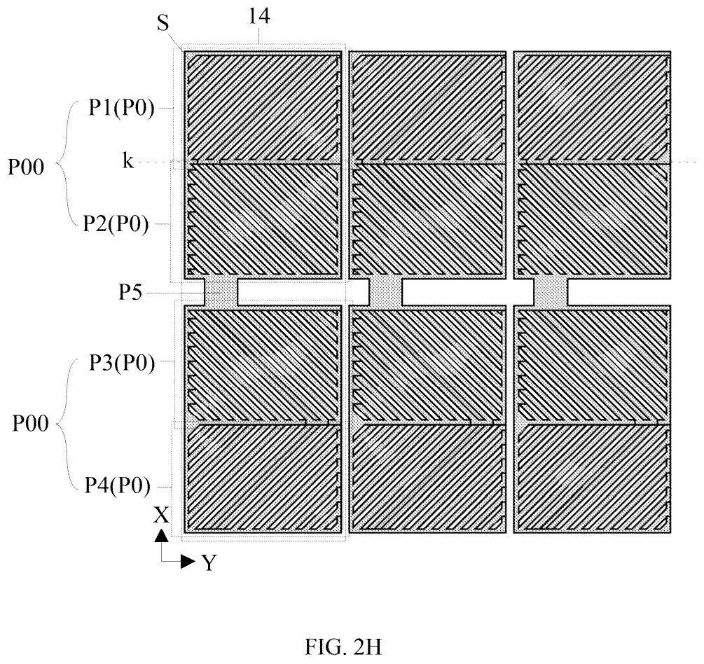

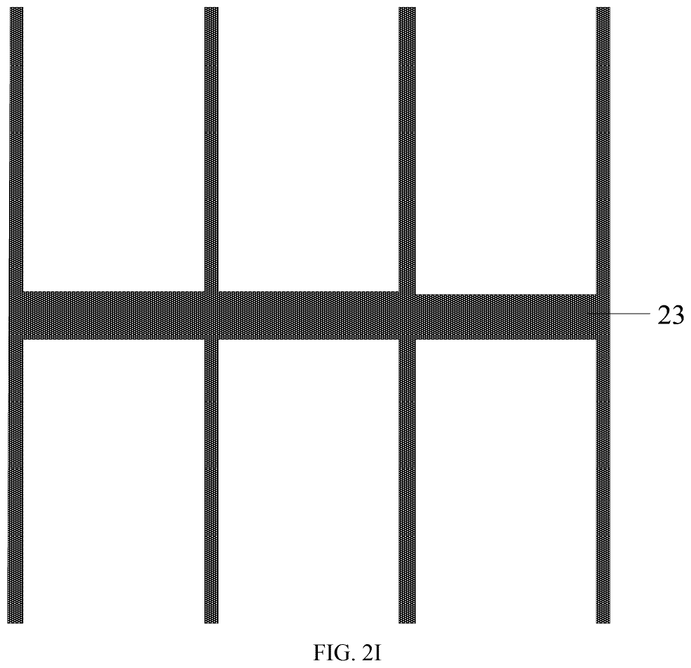

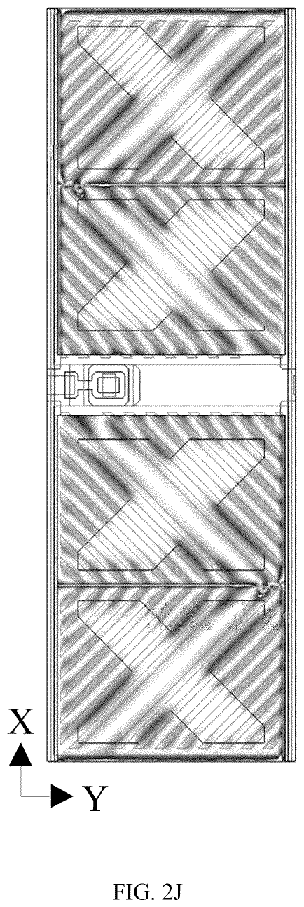

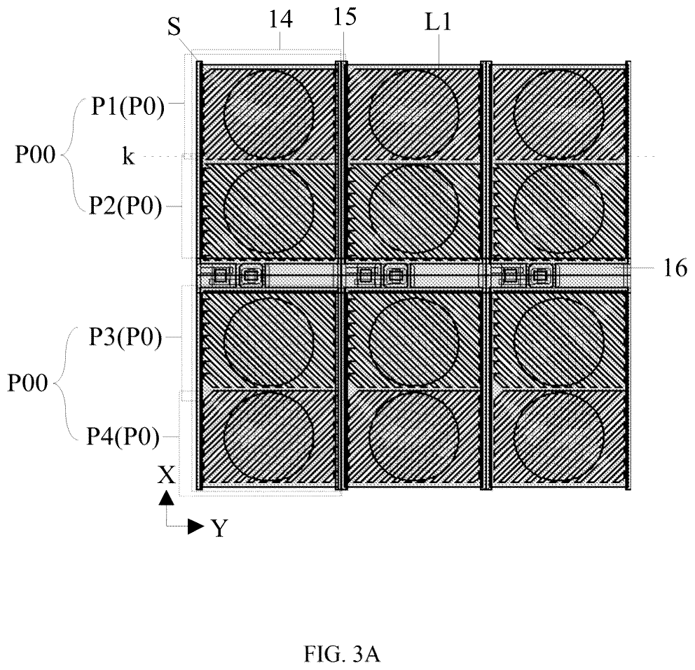

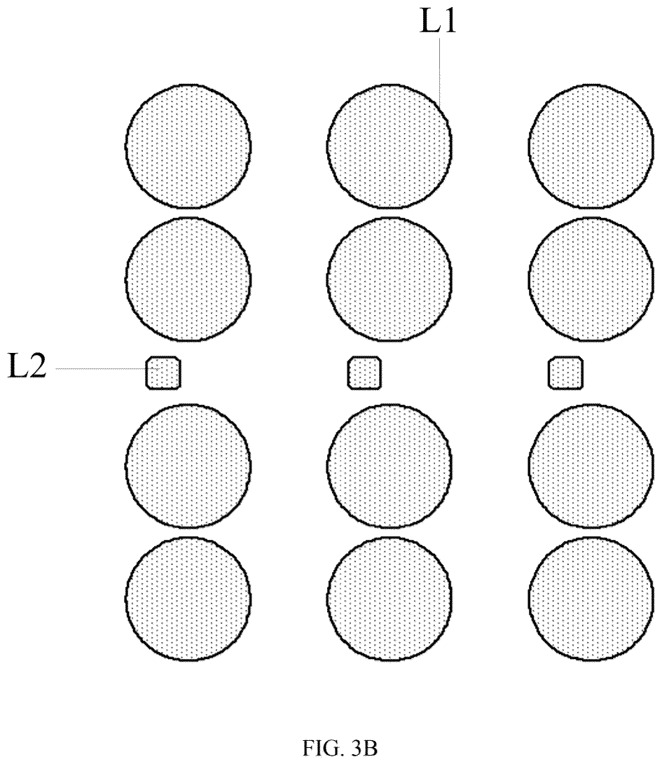

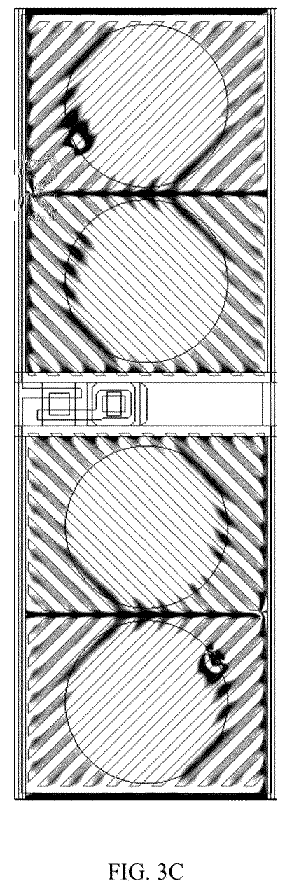

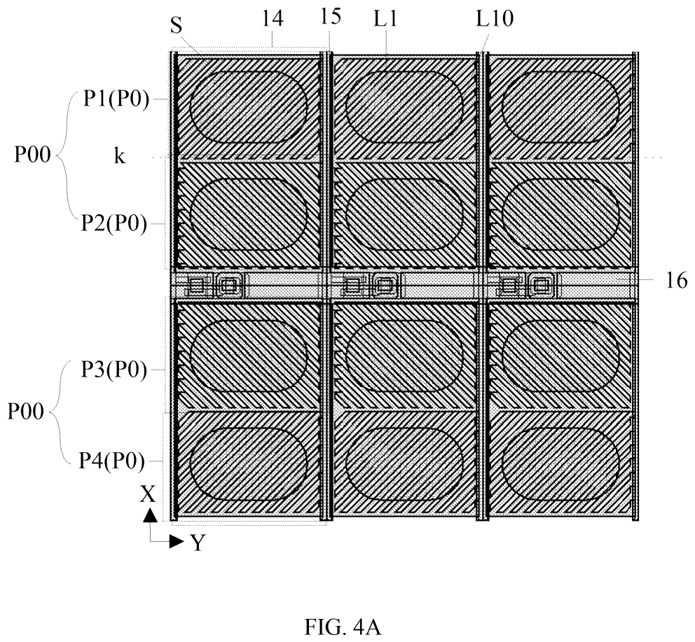

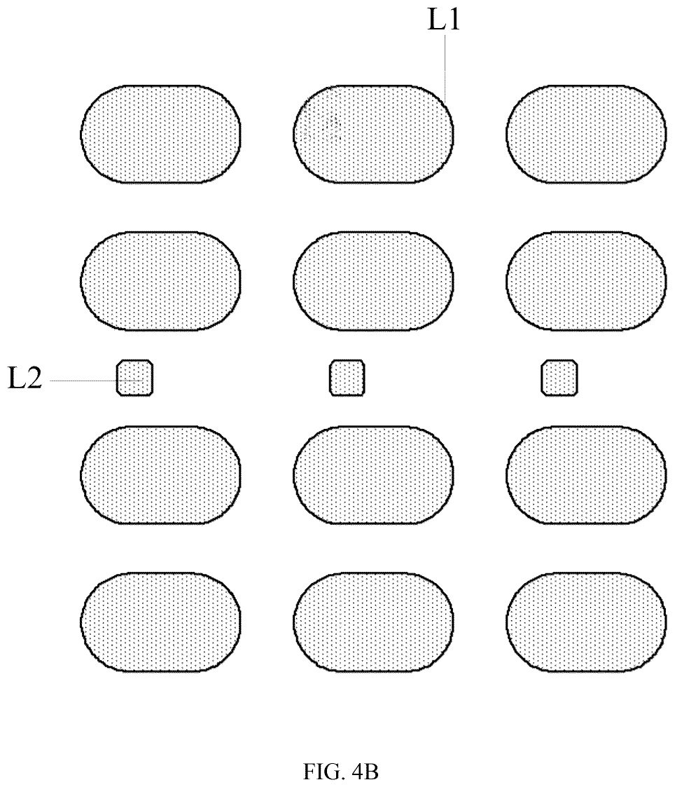

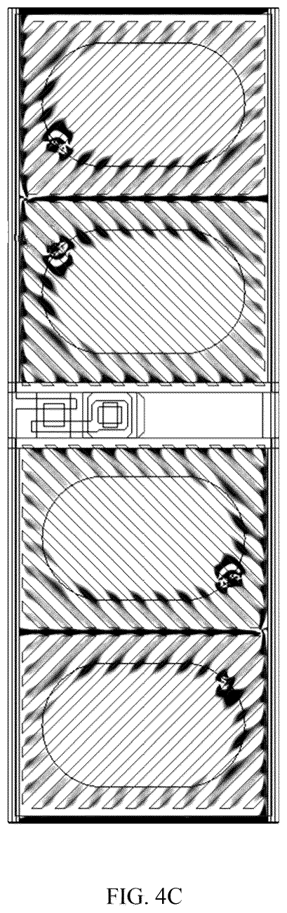

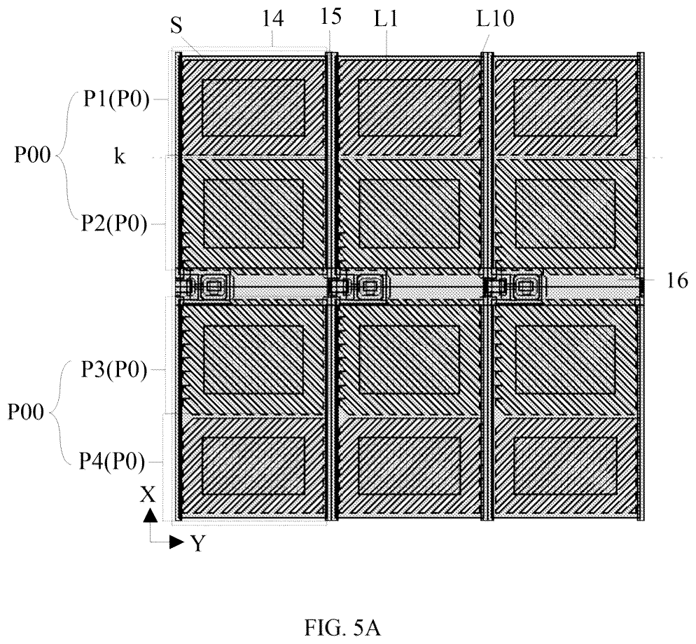

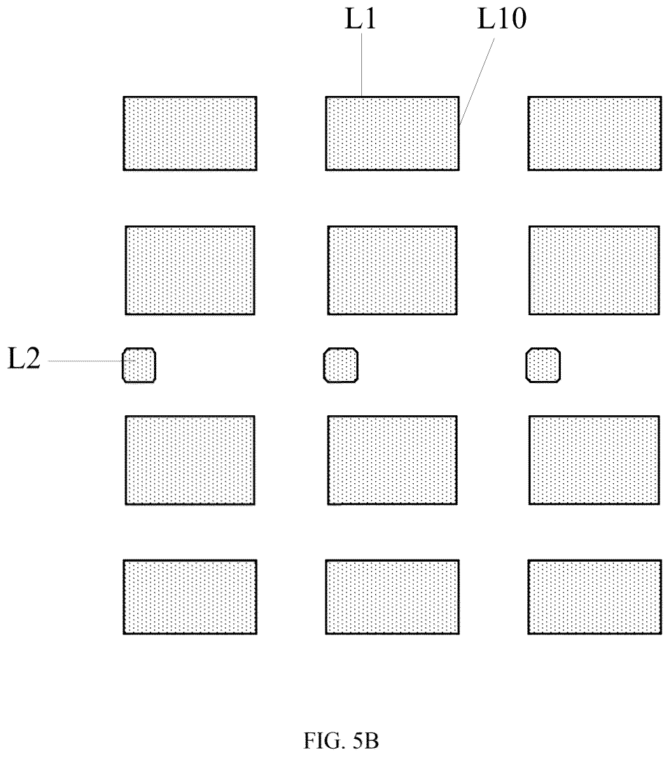

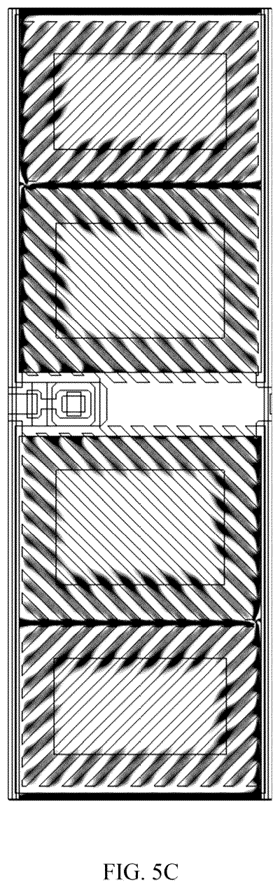

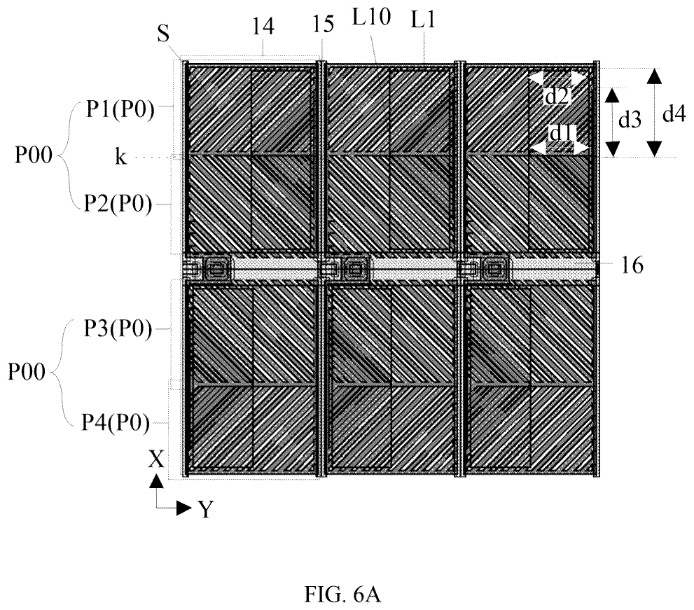

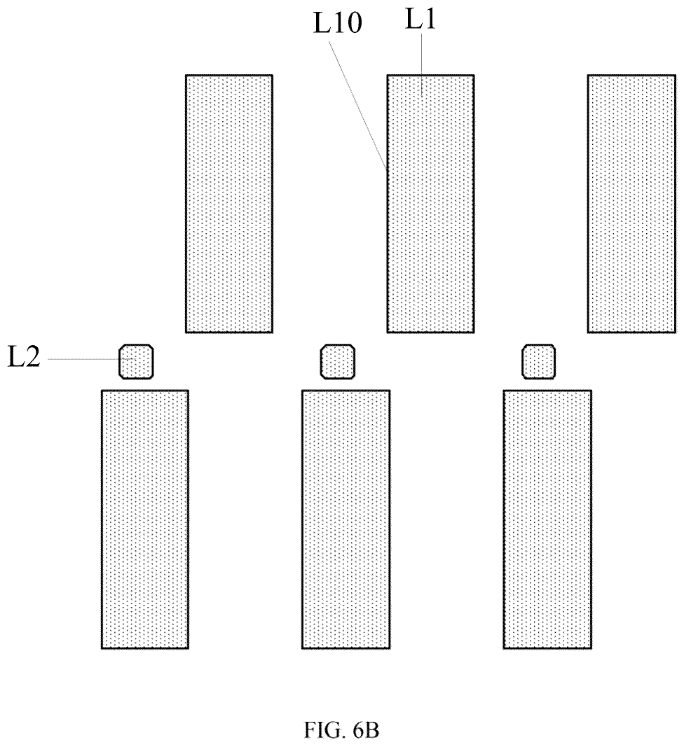

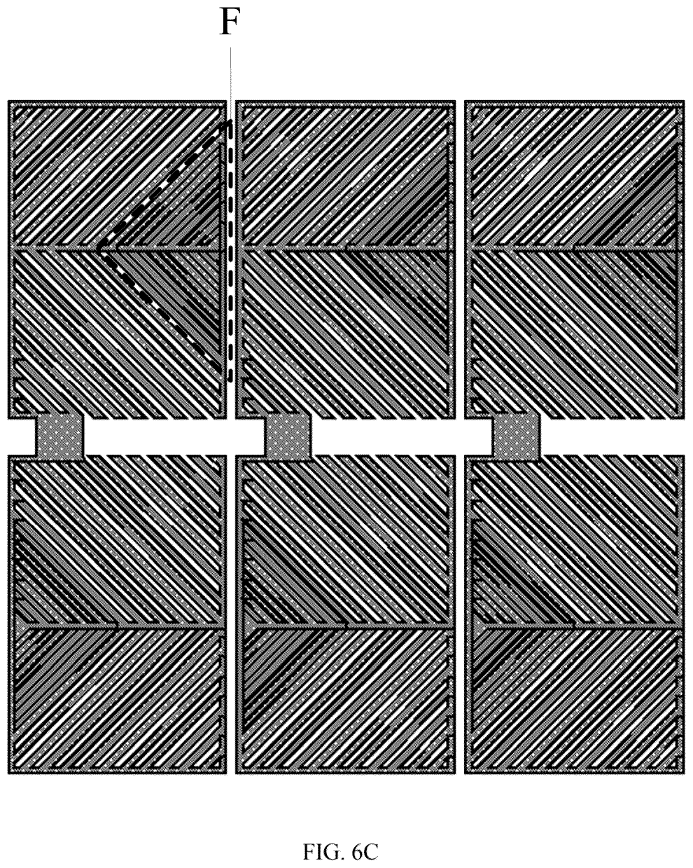

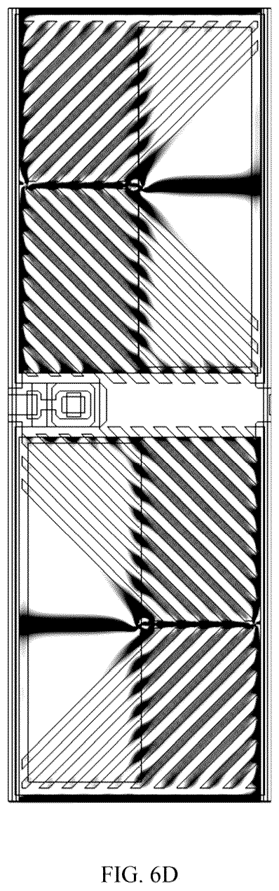

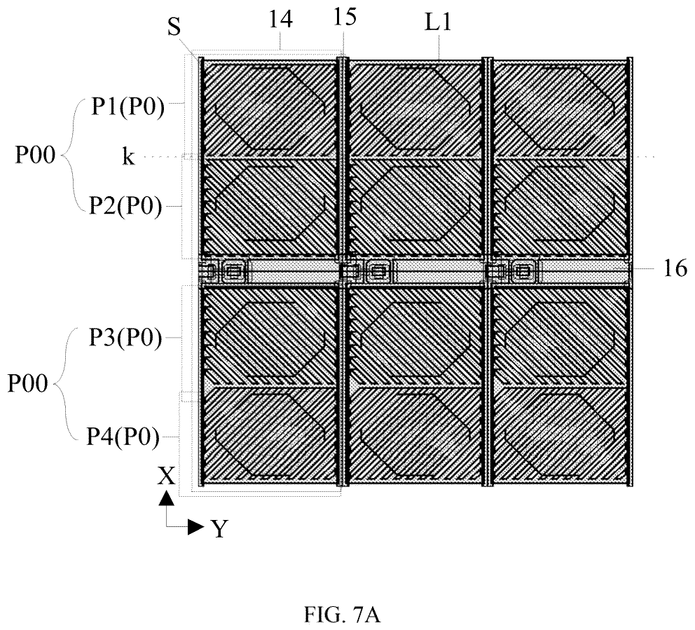

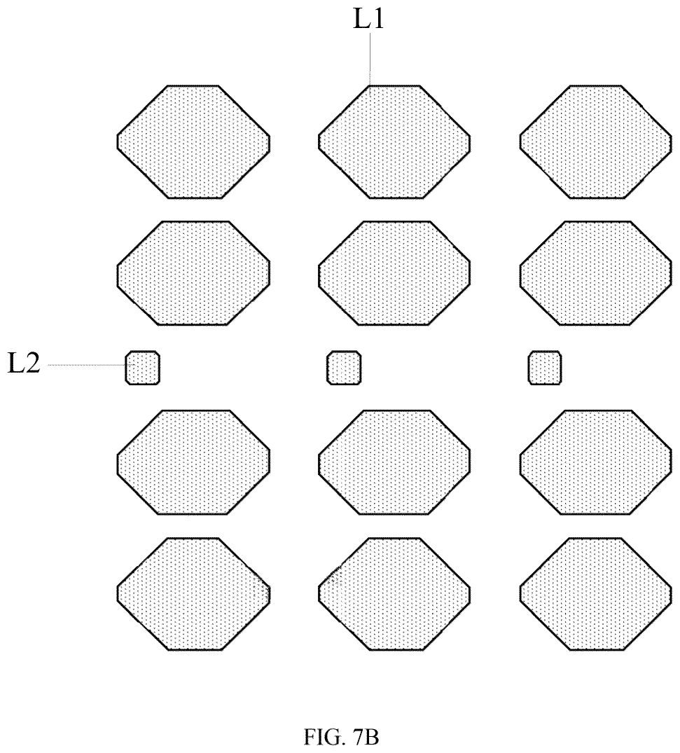

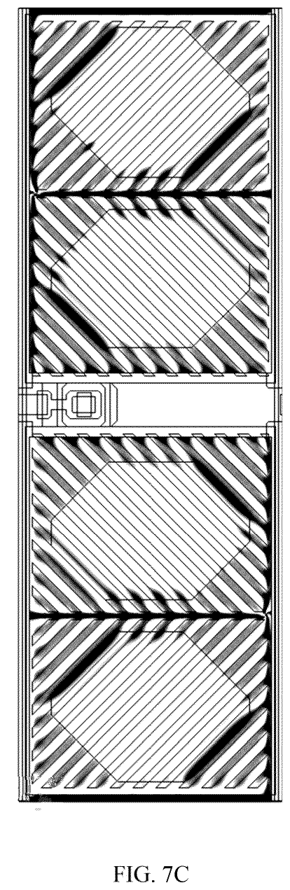

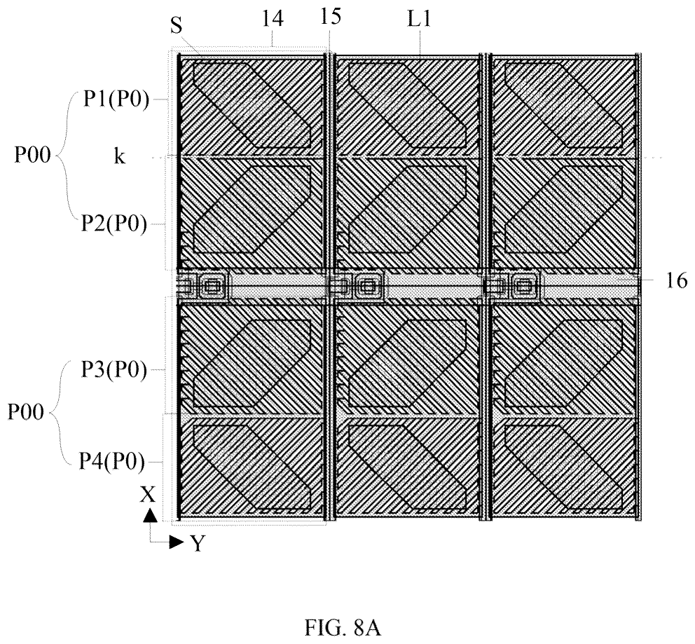

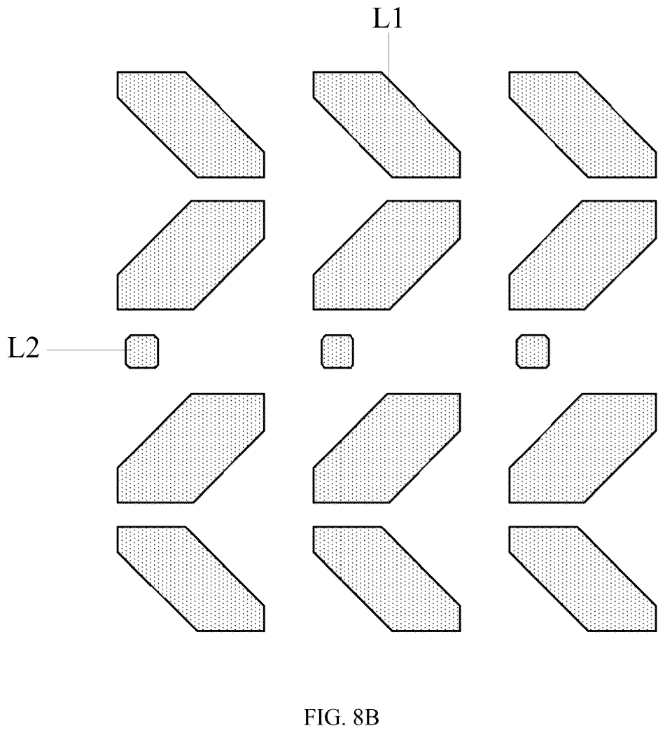

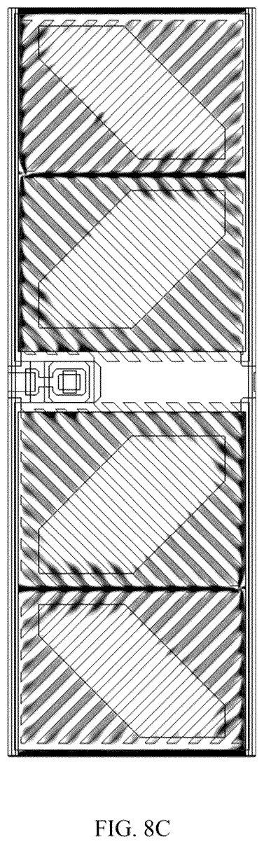

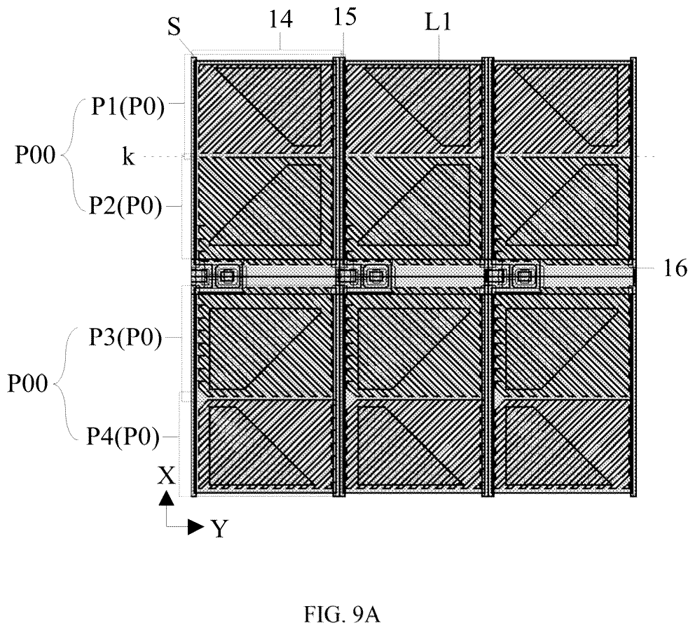

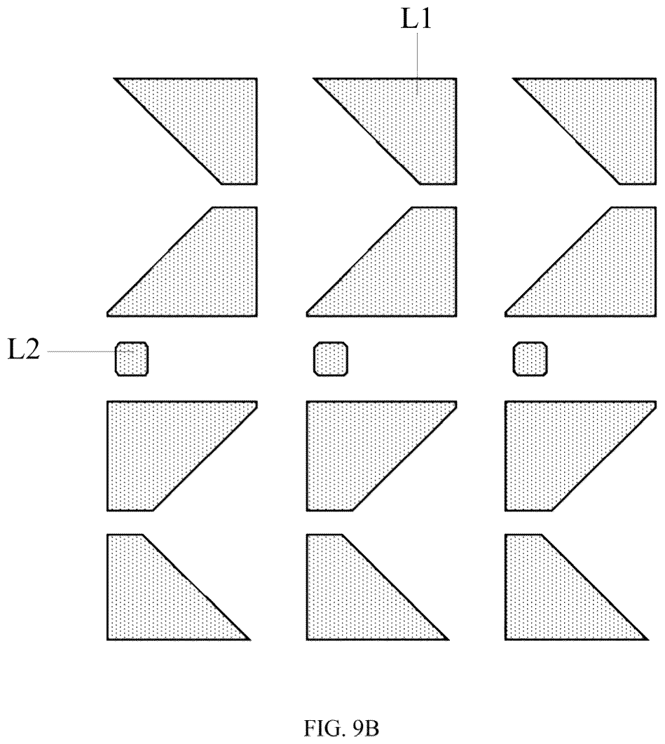

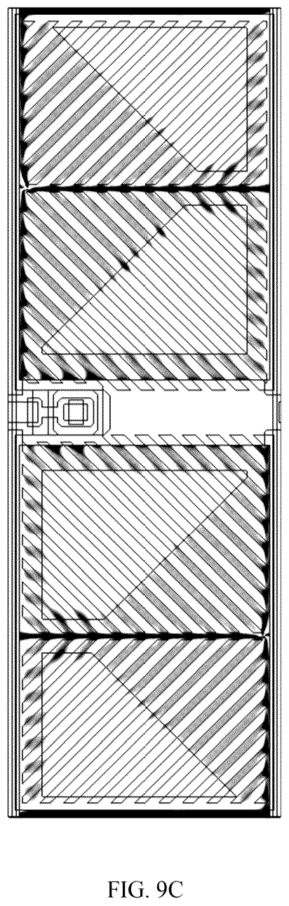

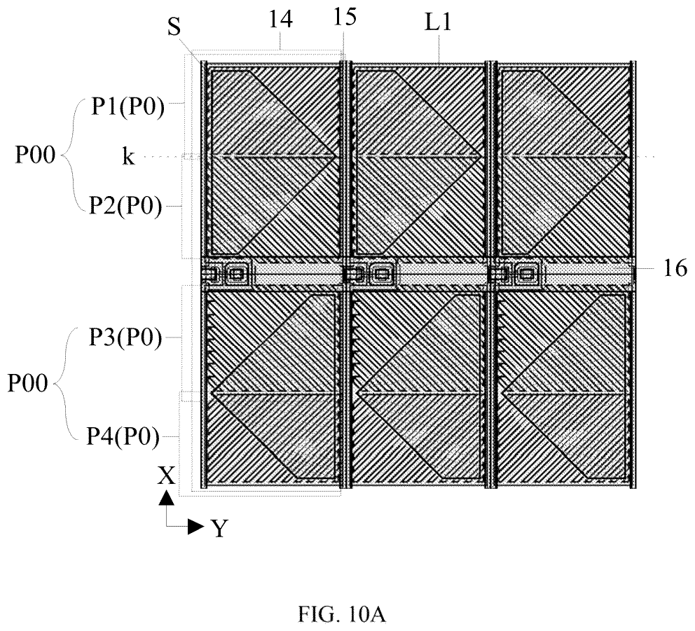

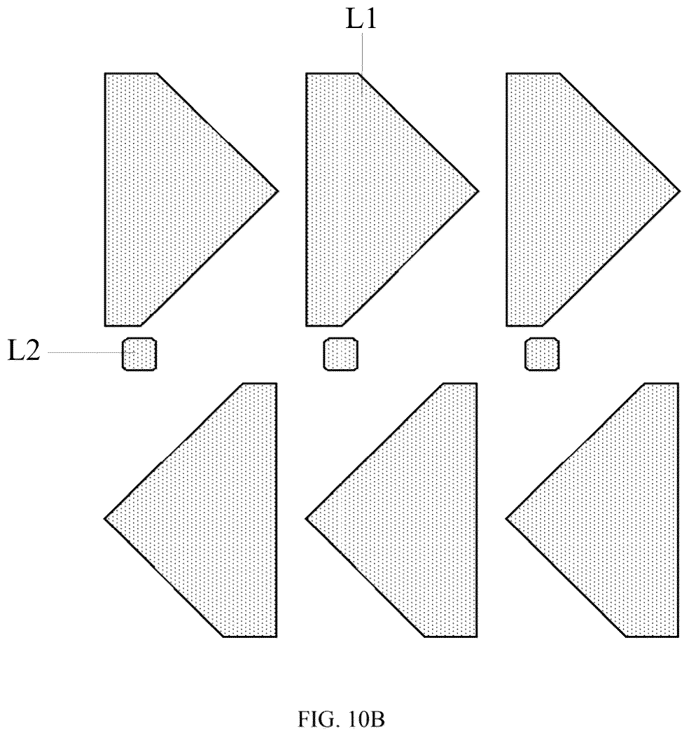

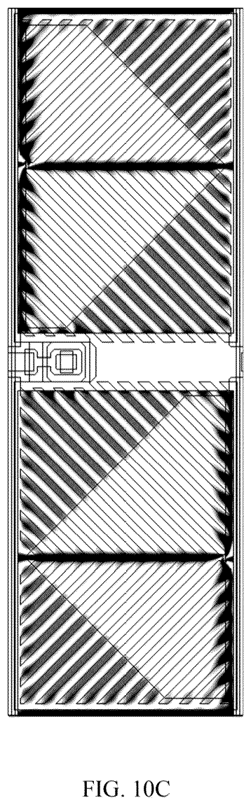

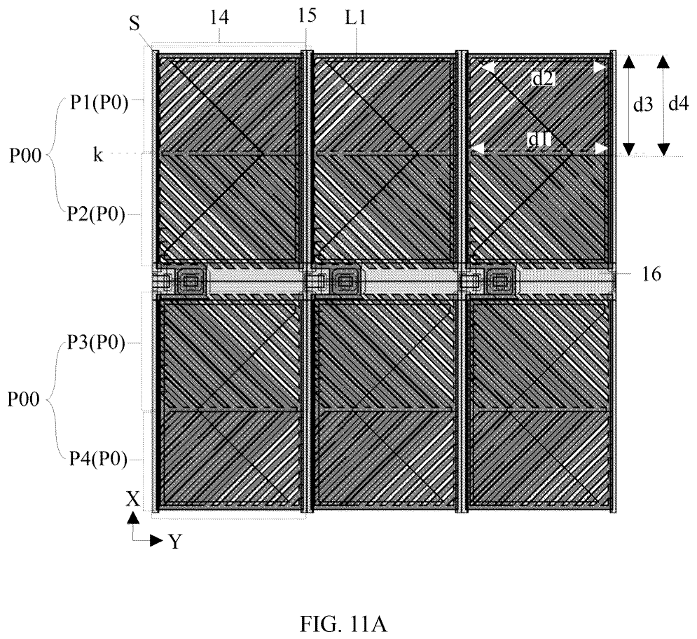

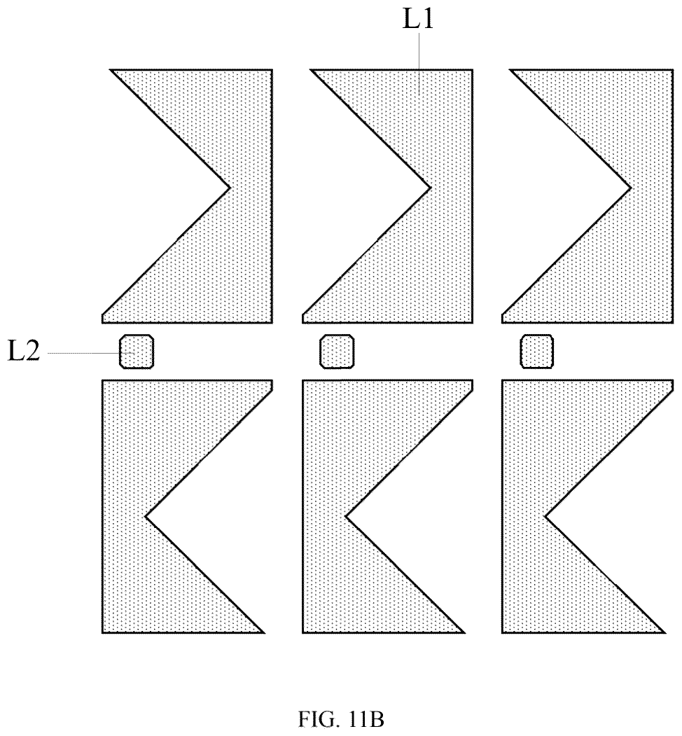

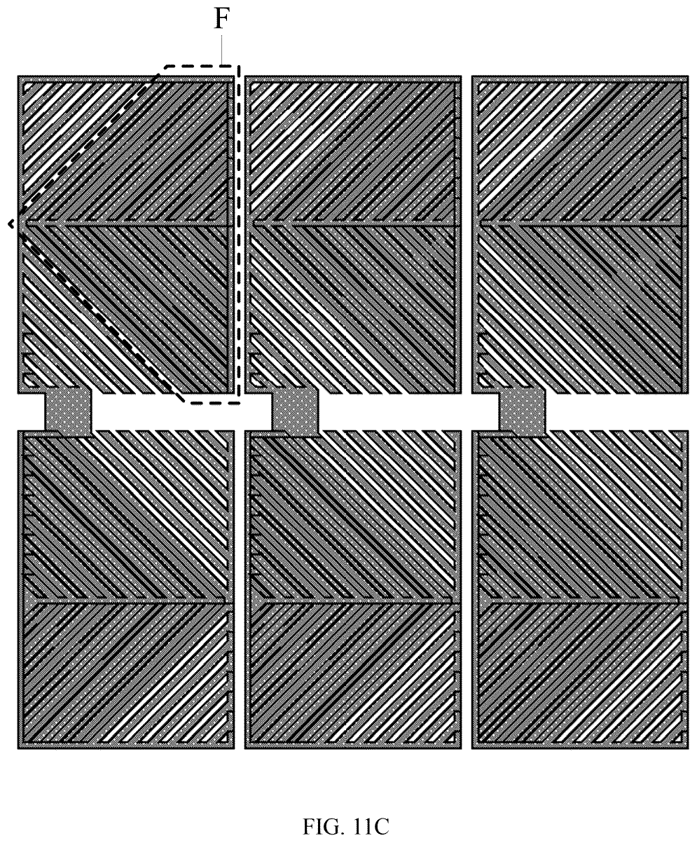

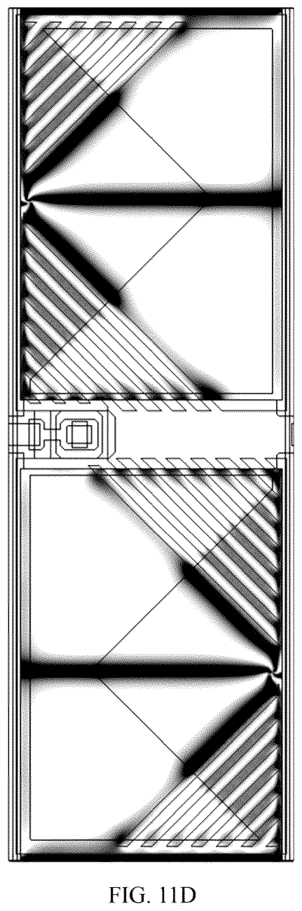

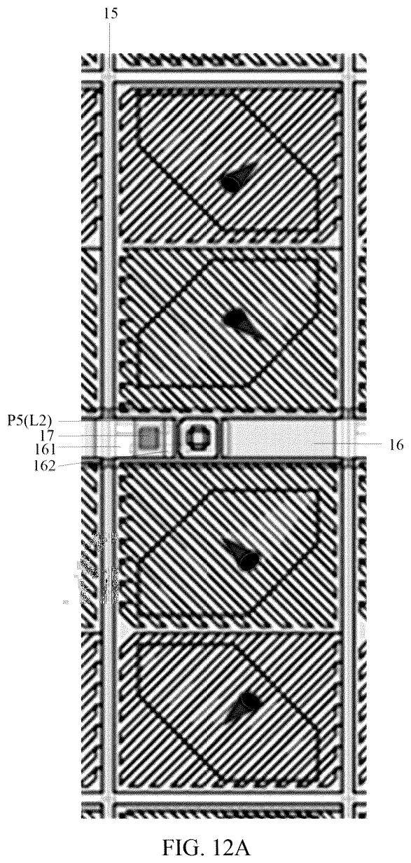

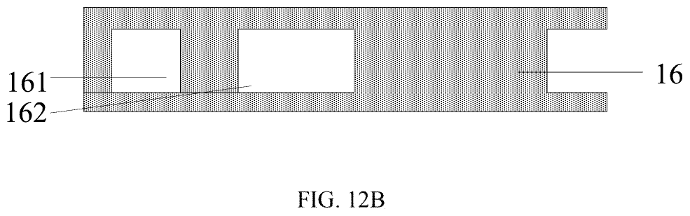

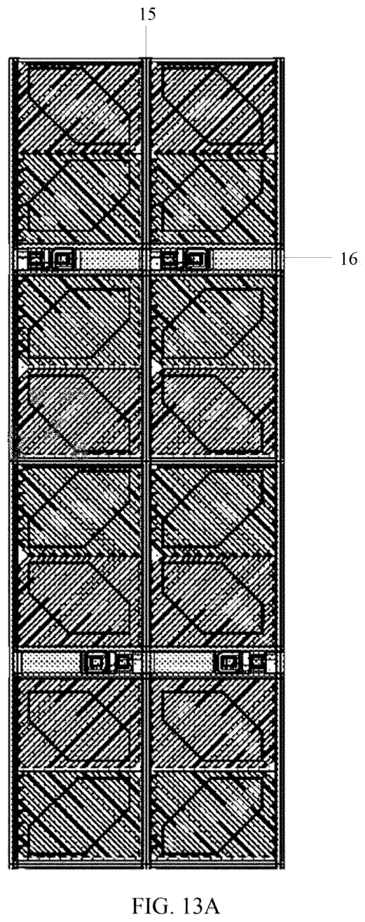

In view of the foregoing, referring to FIG. 1, FIGS. 2A-2J, FIGS. 3A-3C, FIGS. 4A-4C, FIGS. 5A-5C, FIGS. 6A-6D, FIGS. 7A-7C, FIGS. 8A-8C, FIGS. 9A-9C, FIGS. 10A-10C, FIGS. 11A-11D, and FIGS. 12A-12B, FIG. 2A is a first top schematic view of an array substrate provided by embodiments of the present disclosure, FIG. 2B is a schematic diagram of a single film layer of gate lines in FIG. 2A, FIG. 2C is a schematic diagram of a single film layer of data lines in FIG. 2A, FIG. 2D is a schematic diagram of a single film layer of an active layer in FIG. 2A, FIG. 2E is a schematic diagram of a single film layer of a first insulating layer in FIG. 2A, FIG. 2F is a schematic diagram of a single film layer of a first electrode in FIG. 2A, FIG. 2G is a schematic diagram of a single film layer of a second insulating layer in FIG. 2A, FIG. 2H is a schematic diagram of a single film layer of a pixel electrode of FIG. 2A, FIG. 2I is a schematic diagram of a black matrix corresponding to FIG. 2A, FIG. 2J is an optical simulation corresponding to FIG. 2A, FIG. 3A is a second top schematic view of an array substrate provided by embodiments of the present disclosure, FIG. 3B is a schematic diagram of a single film layer of a first electrode in FIG. 3A, FIG. 3C is an optical simulation corresponding to FIG. 3A, FIG. 4A is a third top schematic view of an array substrate provided by embodiments of the present disclosure, FIG. 4B is a schematic diagram of a single film layer of a first electrode in FIG. 4A, FIG. 4C is an optical simulation corresponding to FIG. 4A, FIG. 5A is a fourth top schematic view of an array substrate provided by embodiments of the present disclosure, FIG. 5B is a schematic diagram of a single film layer of a first electrode in FIG. 5A, FIG. 5C is an optical simulation corresponding to FIG. 5A, FIG. 6A is a fifth top schematic view of an array substrate provided by embodiments of the present disclosure, FIG. 6B is a schematic diagram of a single film layer of a first electrode in FIG. 6A, FIG. 6C is a schematic diagram of a single film layer of a pixel electrode in FIG. 6A, FIG. 6D is an optical simulation corresponding to FIG. 6A, FIG. 7A is a sixth top schematic view of an array substrate provided by embodiments of the present disclosure, FIG. 7B is a schematic diagram of a single film layer of a first electrode in FIG. 7A, FIG. 7C is an optical simulation corresponding to FIG. 7A, FIG. 8A is a seven top schematic view of an array substrate provided by embodiments of the present disclosure, FIG. 8B is a schematic diagram of a single film layer of a first electrode in FIG. 8A, FIG. 8C is an optical simulation corresponding to FIG. 8A, FIG. 9A is an eight top schematic view of an array substrate provided by embodiments of the present disclosure, FIG. 9B is a schematic diagram of a single film layer of a first electrode in FIG. 9A, FIG. 9C is an optical simulation corresponding to FIG. 9A, FIG. 10A is a ninth top schematic view of an array substrate provided by embodiments of the present disclosure, FIG. 10B is a schematic diagram of a single film layer of a first electrode in FIG. 10A, FIG. 10C is an optical simulation corresponding to FIG. 10A, FIG. 11A is a tenth top schematic view of an array substrate provided by embodiments of the present disclosure, FIG. 11B is a schematic diagram of a single film layer of a first electrode in FIG. 11A, FIG. 11C is a schematic diagram of a single film layer of a pixel electrode in FIG. 11A, FIG. 11D is an optical simulation corresponding to FIG. 11A, FIG. 12A is an eleventh top schematic view of an array substrate provided by embodiments of the present disclosure, and FIG. 12B is a schematic diagram of a single film layer of gate lines corresponding to FIG. 12A. Embodiments of the present disclosure provide a display panel, including: an array substrate 1 and an opposite substrate 2 opposite to each other; a plurality of data lines 15, located in the array substrate 1, and extending along a first direction X; a plurality of pixel electrodes 14, located in the array substrate 1, where at least one of the plurality of pixel electrodes 14 includes: a plurality of sub-pixel electrode portions P0 arranged along the first direction X; a first electrode 12, located in the array substrate 1, where the first electrode 12 includes a plurality of first hollow portions L1, an orthographic projection of the first hollow portions L1 on the array substrate 1 is within an orthographic projection of the sub-pixel electrode portions P0 on the array substrate 1; the first hollow portions L1 may be one-to-one corresponding to the sub-pixel electrode portions P0, i.e., one first hollow portion L1 is provided in a region corresponding to each of the sub-pixel electrode portions P0; and a common electrode 22, located in the opposite substrate 2.

In the embodiments of the present disclosure, for a display panel of a VA display mode in which the array substrate 1 is provided with the pixel electrode 14 and the opposite substrate 2 is provided with the common electrode 22, and the array substrate is also provided with the first electrode 12 with the first hollow portions L1, when the display is performed, the first electrode 12 forms a capacitance with the pixel electrode 14 at a position where there is no first hollow portion L1, which affects a voltage between the pixel electrode 14 and the common electrode 22 or divides a portion of the voltage to cause a voltage at the position without the first hollow portion L1 to be lower than a voltage at the position with the first hollow portion L1, so that the brightness at the position without the first hollow portion L1 is lower than the brightness at the position with the first hollow portion L1, and regions of different brightnesses are formed within one sub-pixel electrode portion P0, thereby realizing an 8 domain display effect with different brightnesses and darknesses, and a high-resolution display can be realized. The first hollow portion L1 can be of various shapes, which makes it easy to realize different ratios of light and dark regions. Furthermore, within one pixel electrode 14, the voltage difference at the position with the first hollow portion L1 and the voltage difference at the position without the first hollow portion L1 are different, which allows for a more uniform liquid crystal torsion, reduces the dark patterns corresponding to the pixel electrode 14, and decreases the width of the black matrix, and improves the transmittance rate of the display panel. Furthermore, in addition to a vertical electric field formed by the pixel electrodes 14 and the common electrode 22 within the array substrate, the pixel electrodes 14 and the first electrode 12 will form a transverse electric field, which can increase the direction of deflection of the liquid crystals, and can eliminate the color shift of the display panel. Furthermore, corresponding to each sub-pixel, the above effect can be achieved by using only 1 transistor, and the pixel structure of the display panel is simple and easy to be realized.

It should be noted that in FIG. 2F, FIG. 3B, FIG. 4B, FIG. 5B, FIG. 6B, FIG. 7B, FIG. 8B, FIG. 9B, FIG. 10B, and FIG. 11B, in order to clearly illustrate the shape of the first hollow portion L1, the first hollow portions L1 and the second hollow portions L2 are represented by a pattern having filled dots; and the region other than the first hollow portions L1, the second hollow portions L2 is treated as an effective region of the first electrode 12, that is, the region beyond the first hollow portions L1, the second hollow portions L2 is the region with the solid first electrode 12, and the first hollow portions L1 and the second hollow portions L2 of the filled dots is the hollowed out regions.

In a possible implementation, as shown in conjunction with FIGS. 1, 2A-2J, the array substrate 1 may include: a first substrate 11, a plurality of gate lines 16 which is on a side of the first substrate 11 and extends along the second direction Y, data lines 15 on a side of the gate lines 16 facing away from the first substrate 11, the first electrode 12 on a side of the data lines 15 facing away from the gate lines 16, and the pixel electrode 14 on a side of the first electrode 12 facing away from the data lines 15. A gate insulating layer may also be provided between a layer in which the gate lines 16 are located and a layer in which the data lines 15 are located, an active layer may also be provided between the gate insulating layer and the layer in which the data lines 15 are located (the active layer may include an active pattern 17, and the material of the active layer may be amorphous silicon, low-temperature polycrystalline silicon, metal oxides, etc., which is not limited herein), a first insulating layer 18 may also be provided between the layer in which the data lines 15 are located and the first electrode 12, and a second insulating layer 13 may be provided between the first electrode 12 and the pixel electrode 14.

In a possible implementation, as shown in conjunction with FIG. 2I, the display panel may further be provided with a black matrix 23, and an orthographic projection of the black matrix 23 on the array substrate 1 may cover an orthographic projection of the gate lines 16 on the array substrate, as well as cover an orthographic projection of the data lines 15 on the array substrate 1. The opposite substrate may include a second substrate 21, and the black matrix 23 may be between the second substrate 21 and the common electrode 22.

In a possible implementation, as shown in conjunction with FIG. 1, the first electrode 12 is located on a side of the pixel electrode 14 away from the opposite substrate 2. In the embodiments of the present disclosure, the first electrode 12 is located on the side of the pixel electrode 14 facing away from the opposite substrate 2, which can isolate the first overlapping capacitance Cgp between the pixel electrode 14 and the gate line 16 and the second overlapping capacitance Cpd between the pixel electrode 14 and the data line 15, which greatly reduces the risk of crosstalk (crosstalk). Meanwhile, due to the presence of the first electrode 12, the distance between the pixel electrodes can be reduced so that the pixel electrodes 14 are overlapped with the gate lines 16 and the pixel electrodes 14 are overlapped with the data lines 15, which reduces the risk of light leakage from the liquid crystals, and thereby reduces the width of the black matrix, increases the pixel opening rate, and improves the pixel transmittance rate.

In a possible implementation, the first electrode 12 is loaded with the same signal as the common electrode 22. That is, the first electrode 12 is also loaded with the common signal.

In a possible implementation, referring to FIGS. 2A-2J, FIGS. 3A-3C, FIGS. 4A-4C, FIGS. 5A-5C, FIGS. 6A-6D, FIGS. 7A-7C, FIGS. 8A-8C, FIGS. 9A-9C, FIGS. 10A-10C, and FIGS. 11A-11D, the plurality of sub-pixel electrode portions P0 include: two sub-pixel electrode groups P00 distributed along the first direction X, the sub-pixel electrode group P00 includes two sub-pixel electrode portions P0, the sub-pixel electrode portions P0 is provided with a plurality of slit structures S extending along the same direction, and the slit structures S of the two sub-pixel electrode portions P0 which are adjacent to each other and are included in the sub-pixel electrode group P00 extend in different directions.

In a possible implementation, referring to FIGS. 2A-2J, FIGS. 3A-3C, FIGS. 4A-4C, FIGS. 5A-5C, FIGS. 6A-6D, FIGS. 7A-7C, FIGS. 8A-8C, FIGS. 9A-9C, FIGS. 10A-10C, and FIGS. 11A-11D, the plurality of sub-pixel electrode portions P0 include: a first sub-pixel electrode portion P1 a second sub-pixel electrode portion P2, a third sub-pixel electrode portion P3, and a fourth sub-pixel electrode portion P4 arranged sequentially along the first direction X; an extension direction of the slit structures S of the first sub-pixel electrode portion P1 is the same as an extension direction of the slit structures S of the third sub-pixel electrode portion P3, and an extension direction of the slit structures S of the second sub-pixel electrode portion P2 is the same as an extension direction of the slit structures S of the fourth sub-pixel electrode portion P4.

In a possible implementation, the angle formed between the extension direction of the slit structures S of the first sub-pixel portion P1 and the second direction Y may be 40° to 50°, for example, may be 45°; and the angle formed between the extension direction of the slit structures S of the second sub-pixel portion P2 and the second direction Y may be 130° to 140°, for example, may be 135°.

In a possible implementation, referring to FIGS. 2A-2J, FIGS. 3A-3C, FIGS. 4A-4C, FIGS. 5A-5C, FIGS. 6A-6D, FIGS. 7A-7C, FIGS. 8A-8C, FIGS. 9A-9C, FIGS. 10A-10C, and FIGS. 11A-11D, an orthographic projection of the gate line 16 on the array substrate 1 has an overlapping region with an orthographic projection of a gap between the second sub-pixel electrode portion P2 and the third sub-pixel electrode portion P3 on the array substrate 1. That is, the gate line 16 is located at the position of the gap between two sub-pixel electrode groups P00 of one pixel electrode 14

The region defined by the gate lines 16 and the data lines 15 that are intersected with each other may be the region where the pixel electrodes 14 are located. The sub-pixel electrode portion P0 is in the region where the pixel electrode 14 is located, and by this way, the first hollow portion L1 of the first electrode 12 and the sub-pixel electrode portion P0 that is in the region where the pixel electrode 14 is located are overlapped.

In a possible implementation, referring to FIGS. 2A-2J, FIGS. 3A-3C, FIGS. 4A-4C, FIGS. 5A-5C, FIGS. 6A-6D, FIGS. 7A-7C, FIGS. 8A-8C, FIGS. 9A-9C, FIGS. 10A-10C, and FIGS. 11A-11D, the pixel electrode 14 further includes: a connection portion P5 that connects the second sub-pixel electrode portion P2 to the third sub-pixel electrode portion P4; and two sub-pixel electrode groups P00 of one pixel electrode 14 are connected via the connection portion P5. The connection portion P5 may be located in the same layer as the pixel electrode 14.

As shown in conjunction with FIGS. 2A-2J, the layer where the data lines 15 are located may also include a first electrode(s) 151 of a transistor(s) (optionally, the data line is multiplexed as the first electrode 151 of the transistor), and a second electrode(s) 152 of the transistor(s); and an orthographic projection of the connection portion P5 on the array substrate 1 may have an overlapping region with an orthographic projection of the second electrode 152 of the transistor on the array substrate 1 to make conduction between the pixel electrode 14 and the second electrode 152 of the transistor through a via hole.

As shown in conjunction with FIGS. 2A-2J, the first electrode 12 further includes: a second hollow portion L2, where an orthographic projection of the second hollow portion L2 on the array substrate 1 at least partially covers the orthographic projection of the connection portion P5 on the array substrate 1. Optionally, an orthographic projection of the second hollow portion L2 on the array substrate 1 completely covers the orthographic projection of the connection portion P5 on the array substrate 1. The first insulating layer further includes a first via hole K1, and the second insulating layer further includes the second via hole K2; the orthographic projection of the connection portion P5 on the array substrate 1, an orthographic projection of the second via hole K2 on the array substrate 1, the orthographic projection of the second hollow portion L2 on the array substrate 1, an orthographic projection of the first via hole K1 on the array substrate 1, and the orthographic projection of the second electrode of the transistor 152 on the array substrate 1 all have an overlapping region to make conduction between the connection portion P5 and the second electrode 152 of the transistor through the second via hole K2, the second hollow portion L2, and the first via hole K1 in turn.

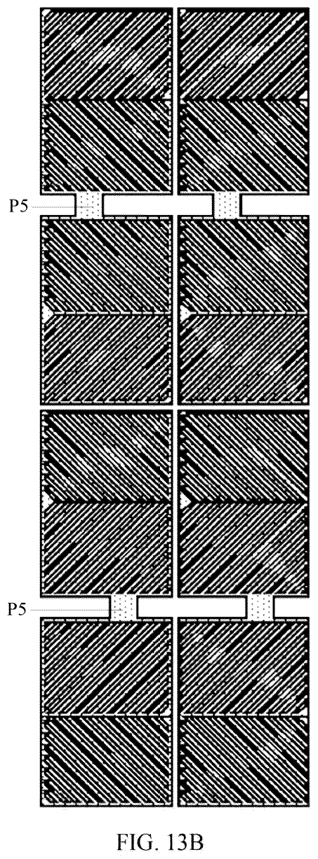

Referring to FIGS. 13A and 13B, extension lines of the connection portions 14 of two pixel electrodes 14 which are adjacent to each other in the first direction X do not coincide with each other. That is, the connection portions 14 of two pixel electrodes 14 are staggered with each other in the first direction X, so that one data line 15 can connect to pixel electrodes 14 in different columns. For example, in FIG. 13A, the data line 15 sorted second from the left connects the pixel electrode 14 sorted first on the right above, and also connects the pixel electrode 14 on the left below, and the two connected pixel electrodes 14 are in different columns.

In a possible implementation, referring to FIGS. 12A and 12B, the gate line 16 includes a first gate line hollow 161; where an orthographic projection of the first gate line hollow 161 on the array substrate 1 is overlapped with an orthographic projection of a portion of the data line 15 on the array substrate 1. In embodiments of the present disclosure, the gate line 16 is hollowed out in the region where it overlaps with the data line 15 to avoid the two from generating an overlapping capacitance, which affects the signal transmission of the gate line 16 as well as the data line 15.

In a possible implementation, referring to FIGS. 12A and 12B, the gate line 16 further includes a second gate line hollow 162, where an orthographic projection of the second gate line hollow 162 on the array substrate 1 is at least partially overlapped with an orthographic projection of the connection portion P5 on the array substrate 1. In embodiments of the present disclosure, the gate line 16 is hollowed out in the region where it overlaps with the connection portion P5 to avoid the gate line 16 from generating overlapping capacitance with the pixel electrodes 14, which affects the signal transmission of the gate line 16.

In a possible implementation, referring to FIGS. 2A-2J, FIGS. 3A-3C, FIGS. 4A-4C, FIGS. 5A-5C, FIGS. 6A-6D, FIGS. 7A-7C, FIGS. 8A-8C, FIGS. 9A-9C, FIGS. 10A-10C, and FIGS. 11A-11D, the first gate line hollow 161 and the second gate line hollow 162 may also be of one-piece structure, that is, the connecting slots are cut in the gate line 16 to be used as both the first gate line hollow 161 as well as the second gate line hollow 162.

It should be noted that FIGS. 3A-3C, FIGS. 4A-4C, FIGS. 5A-5C, FIGS. 6A-6D, FIGS. 7A-7C, FIGS. 8A-8C, FIGS. 9A-9C, FIGS. 10A-10C, and FIGS. 11A-11D only illustrate a stacked diagram of the array substrate and a single film layer diagram of the first electrode 12 or the pixel electrodes 14, and the other film layer patterns of the array substrate may be shown in FIGS. 2A-2I, which are not attached in the embodiments of the present disclosure.

In a possible implementation, referring to FIGS. 2A-2J, FIGS. 3A-3C, FIGS. 4A-4C, FIGS. 5A-5C, FIGS. 6A-6D, FIGS. 7A-7C, FIGS. 8A-8C, FIGS. 9A-9C, FIGS. 10A-10C, and FIGS. 11A-11D, an axle line k extending along the first direction X is between two sub-pixel electrode portions P0 of one sub-pixel electrode group P00; and the two first hollow portions L1 corresponding to the one sub-pixel electrode group P00 are symmetrical with respect to the axis line k.

In a possible implementation, referring to FIG. 2A, FIG. 3A, FIG. 4A, FIG. 5A, FIG. 7A, and FIG. 8A, a region of a center of an orthographic projection of the first hollow portion L1 on the array substrate 1 coincides with a region of a center of an orthographic projection of the sub-pixel electrode portion P0 on the array substrate 1. The center of the orthographic projection of the first hollow portion L1 on the array substrate 1 is overlapped with the center of the orthographic projection of the sub-pixel electrode portion P0 on the array substrate 1.

In a possible implementation, referring to FIGS. 3A-3C, and FIGS. 4A-4C, the orthographic projection of the first hollow portion L1 on the array substrate 1 is a circle or an ellipse.

In a possible implementation, referring to FIGS. 5A-5C, and FIGS. 6A-6D, the orthographic projection of the first hollow portion L1 on the array substrate 1 is a rectangle, and at least one edge of the rectangle is parallel to an outer edge of the sub-pixel electrode portion P0. For example, as shown in FIGS. 5A-5C and FIGS. 6A-6D, an edge of the rectangle extending along the first direction X is parallel to an edge of the sub-pixel electrode portion P0 extending along the first direction X, i.e., both extend along the first direction X. An edge of the rectangle extending along the second direction Y is parallel to an edge of the sub-pixel electrode portion P0 extending along the second direction Y, i.e., both extend along the second direction Y.

It should be noted that the outer edge of the sub-pixel electrode portion P0 may be an actual outer edge of the pixel electrode, or may be an extension of a branch electrode tip of the pixel electrode (e.g., the pixel electrode is comb-tooth shaped, and the outer edge of the sub-pixel electrode portion P0 may be an extension of the branch electrode tip).

In a possible implementation, referring to FIGS. 5A-5C, and FIGS. 6A-6D, the first hollow portion L1 includes a first edge L10 that extends along the first direction X; and the extension lines of the first edges L10 of two first hollow portions L1 corresponding to one sub-pixel electrode group P00 coincide with each other. For example, as in FIGS. 5A and 6A, the extension line of the first edge L10 of the first hollow portion L1 corresponding to the first sub-pixel electrode portion P1 coincides with the extension line of the first edge L10 of the first hollow portion L1 corresponding to the second sub-pixel electrode portion P2; and the extension line of the first edge L10 of the first hollow portion L1 corresponding to the third sub-pixel electrode portion P3 coincides with the extension line of the first edge L10 of the first hollow portion L1 corresponding to the fourth sub-pixel electrode portion P4.

In a possible implementation, referring to FIGS. 6A-6D showing that the extension lines of at least one first edge L10 of the first hollow portion L1 corresponding to two sub-pixel electrode groups P00 in the same pixel electrode 14 do not coincide. For example, as shown in FIG. 6A, the extension line of the first edge L10 of the left side of the first hollow portion L1 of the upper sub-pixel electrode group P00 does not coincide with the extension line of the first edge L10 of the left side of the first hollow portion L1 of the lower sub-pixel electrode group P00; and the extension line of the first edge L10 of the right side of the first hollow portion L1 of the upper sub-pixel electrode group P00 does not coincide with the extension line of the first edge L10 of the right side of the first hollow portion L1 of the lower sub-pixel electrode group P00.

In a possible implementation, referring to FIGS. 7A-7C, and FIGS. 8A-8C, the orthographic projection of the first hollow portion L1 on the array substrate 1 is a hexagon, and at least one edge of the hexagon is parallel to an outer edge of the sub-pixel electrode portion P0.

In a possible implementation, referring to FIGS. 7A-7C, the at least one edge of the hexagon is parallel to an extension direction of the slit structures S of the sub-pixel electrode portion P0 in which the hexagon is located.

In a possible implementation, referring to FIGS. 7A-7C, and FIGS. 8A-8C, at least one edge of the hexagon is perpendicular to an extension direction of the slit structures S of the sub-pixel electrode portion P0 in which the hexagon is located.

In a possible implementation, referring to FIGS. 9A-9C, FIGS. 10A-10C, and FIGS. 11A-11C, an orthographic projection of the first hollow portion L1 on the array substrate 1 is a right-angled trapezoid, where at least one edge of the right-angled trapezoid is parallel to an outer edges of the sub-pixel electrode portion P0, and the hypotenuse of the right-angled trapezoid is crosses the extension direction of the slit structures S. For example, the bottom edge, the top edge, and the right-angled edge of the right-angled trapezoid are parallel to the corresponding outer edges of the sub-pixel electrode portion P0, and the hypotenuse of the right-angled trapezoid is perpendicular to the extension direction of the slit structures S.

In a possible implementation, referring to FIGS. 9A-9C, FIGS. 10A-10C, and FIGS. 11A-11C, the right-angled edge of the right-angled trapezoid extends along the first direction X, and the hypotenuse of the right-angled trapezoid is perpendicular to the extension direction of the slit structures S.

It should be understood that the right angle of the first hollow portion L1 may be more difficult to be realized due to process precision limitations, and there may be a certain curvature at the right angle position thereof, that is, the right angle of the first hollow portion L1 may be curved at the position corresponding to the right angle of the first hollow portion L1, and right angles within the range of the process error are all right angles referred to by embodiments of the present disclosure.

In a possible implementation, referring to FIGS. 9A-9C, and FIGS. 11A-11C, top edges of two first hollow portions L1 of right-angled trapezoids corresponding to one sub-pixel electrode group P00 are provided in close proximity to each other. That is, the top edges of the first hollow portions L1 of the two right-angled trapezoids corresponding to one sub-pixel electrode group P00 are provided opposite to each other.

In a possible implementation, referring to FIGS. 10A-FIG. 10C, bottom edges of two first hollow portions L1 of right-angled trapezoids corresponding to one sub-pixel electrode group P00 are provided in close proximity to each other. That is, the bottom edges of the first hollow portions L1 of the two right-angled trapezoids corresponding to one sub-pixel electrode group P00 are provided opposite to each other.

In a possible implementation, referring to FIGS. 9A-9C, FIGS. 10A-10C, and FIGS. 11A-11C, extension lines of right-angled edges of two first hollow portions L1 of right-angled trapezoids corresponding to one sub-pixel electrode group P00 coincide with each other. As shown in FIGS. 10A-10C and FIGS. 11A-11C, the extension lines of the right-angled edges of two first hollow portions L1 of right-angled trapezoids corresponding to one sub-pixel electrode group P00 coincide with each other, which may be two trapezoids merged together to form a one-piece dug-out shape.

In a possible implementation, referring to FIGS. 9A-9C, FIGS. 10A-10C, and FIGS. 11A-11C, an extension line of the right-angled edge of the first hollow portion L1 of a trapezoid corresponding to one of two sub-pixel electrode groups P00 in one pixel electrode 14 does not coincide with an extension line of the right-angled edge of the first hollow portion L1 of a trapezoid corresponding to another of the two sub-pixel electrode groups P00 in the one pixel electrode 14. For example, as shown in FIG. 9B, in one pixel electrode 14, the extension line of the right-angled edge of the trapezoidal first hollow portion L1 corresponding to the upper sub-pixel electrode group P00 does not coincide with the extension line of the right-angled edge of the trapezoidal first hollow portion L1 corresponding to the lower sub-pixel electrode group P00. In one pixel electrode 14, the right-angled edge of the trapezoidal first hollow portion L1 corresponding to the upper sub-pixel electrode group P00 is provided close to the right edge of the pixel electrode 14, and the right-angled edge of the trapezoidal first hollow portion L1 corresponding to the lower sub-pixel electrode group P00 is provided close to the left edge of the pixel electrode 14.

In a possible implementation, referring to FIGS. 2A, 2F, the orthographic projection of the first hollow portion L1 on the array substrate 1 is an X-shape, where the first hollow portion L1 includes: a first hollow sub-portion L01 extending along a third direction G, and a second hollow sub-portion L02 extending along a fourth direction H, and the first hollow sub-portion L01 crosses the second hollow sub-portion L02. The first hollow sub-portion L01 is perpendicular to the second hollow sub-portion L02.

In a possible implementation, as shown in FIGS. 2A and 2F, one of the first hollow sub-portion L01 or the second hollow sub-portion L02 extends in a direction parallel to the extension direction of the slit structures S of the sub-pixel electrode portion P0 in which the one of the first hollow sub-portion L01 or the second hollow sub-portion L02 is located, and another of the first hollow sub-portion L01 or the second hollow sub-portion L02 extends in a direction perpendicular to the extension direction of the slit structures of the sub-pixel electrode portion in which the another of the first hollow sub-portion L01 or the second hollow sub-portion L02 is located. For example, in the region where the first sub-pixel electrode portion P1 is located, the extension direction of the first hollow sub-portion L01 is parallel to the extension direction of the slit structures S, and the extension direction of the second hollow sub-portion L02 is perpendicular to the extension direction of the slit structures S. In the region where the second sub-pixel electrode portion P2 is located, the extension direction of the first hollow sub-portion L01 is perpendicular to the extension direction of the slit structures S, and the extension direction of the second hollow sub-portion L02 is parallel to the extension direction of the slit structures S.

In a possible implementation, referring to FIGS. 6A-6D, FIGS. 10A-10C, and FIGS. 11A-11D, two first hollow portions L1 corresponding to one sub-pixel electrode group P00 are a one-piece structure.

In a possible implementation, referring to FIGS. 2A-2J, FIGS. 3A-3C, FIGS. 4A-4C, FIGS. 5A-5C, FIGS. 7A-7C, FIGS. 8A-8C, and FIGS. 9A-9C, two first hollow portions L1 corresponding to one sub-pixel electrode group P00 are separated structures.

In a possible implementation, the slit structures S are uniformly distributed throughout the sub-pixel electrode portion as shown in FIGS. 2A-2J, FIGS. 3A-3C, FIGS. 4A-4C, FIGS. 5A-5C, FIGS. 7A-7C, FIGS. 8A-8C, FIGS. 9A-9C, FIGS. 10A-10C, FIGS. 12A-12B.

In a possible implementation, referring to FIGS. 6A-6D, and FIGS. 11A-11D, the slit structures S are distributed in only a partial region of the sub-pixel electrode portion P0, and the sub-pixel electrode portion P0 further includes a block structure F, i.e., there is no slit inside the block structure F. In the embodiments of the present disclosure, the slit structures S are distributed in only a partial region of the sub-pixel electrode portion P0, and the sub-pixel electrode portion P0 further includes the block structure F, which can increase the brightness of the pixel in the region where the block structure F is located, enhance the transmittance rate, and, meanwhile, produce a distribution of multiple brightnesses within the pixel, and generate a visual effect of greater than 8 domains.

In a possible implementation, referring to FIGS. 6A-6D, FIGS. 11A-11D, the block structures F in two sub-pixel electrode groups P00 of one pixel electrode 14 are distributed at different positions. For example, as shown in FIGS. 6A-6D, and FIGS. 11A-11D, the block structure F corresponding to the upper sub-pixel electrode group P00 is provided close to the right edge of the pixel electrode 14, the block structure F corresponding to the lower sub-pixel electrode group P00 is provided close to the left edge of the pixel electrode 14; the block structures F in two sub-pixel electrode portions P0 of one sub-pixel electrode group P00 are a one-piece structure. For example, as in FIGS. 6A-6D, and FIGS. 11A-11D, the block structures F corresponding to two sub-pixel electrode portions P0 of the upper sub-pixel electrode group P00 is a one-piece structure.

In a possible implementation, referring to FIGS. 6A-6D, FIGS. 11A-11D, an orthographic projection of the first hollow portion L1 on the array substrate 1 is at least partially overlapped with an orthographic projection of the block structure F on the array substrate 1. For example, in conjunction with FIG. 6A, the orthographic projection of the first hollow portion L1 on the array substrate 1 covers the orthographic projection of the block structure F on the array substrate 1, and the orthographic projection of the widest portion of the block structure F on the array substrate may be disposed within the orthographic projection of the first hollow portion L1 on the array substrate 1. For example again, as shown in FIG. 11A, the orthographic projection of the first hollow portion L1 on the array substrate 1 is at least partially overlapped with the orthographic projection of the block structure F on the array substrate 1.

In a possible implementation, referring to FIG. 6A, a maximum length d1 of the orthographic projection of the block structure F on the array substrate 1 in the second direction Y is less than or equal to a maximum length d2 of the orthographic projection of the first hollow portion L1 on the array substrate 1 in the second direction Y. A maximum length d3 of the orthographic projection of the block structure F on the array substrate 1 in the first direction X is less than or equal to a maximum length d4 of the orthographic projection of the first hollow portion L1 on the array substrate 1 in the first direction X. In a possible implementation, referring to FIG. 11A, a maximum length d1 of the orthographic projection of the block structure F on the array substrate 1 in the second direction Y is greater than or equal to a maximum length d2 of the orthographic projection of the first hollow portion L1 on the array substrate 1 in the second direction Y; and a maximum length d3 of the orthographic projection of the block structure F on the array substrate 1 in the first direction X is greater than or equal to a maximum length d4 of the orthographic projection of the first hollow portion L1 on the array substrate 1 in the first direction X.

In a possible implementation, referring to FIGS. 6A-6D, and FIGS. 11A-11D, the block structures F of the different sub-pixel electrode portions P0 within one sub-pixel electrode group P00 may be a one-piece connection structure. Referring to FIG. 6A, the block structure F may be a right-angled triangle, and the right-angled edges of the two block structures F of the different sub-pixel electrode portions P0 within one sub-pixel electrode group P00 coincide with each other. Referring to FIG. 11A, the block structure F may be a right-angled trapezoid, and bottom edges of the two block structures F of right-angled trapezoids of the different sub-pixel electrode portions P0 within one sub-pixel electrode group P00 are provided in proximity to each other, i.e., the bottom edges of the two right-angled trapezoid block structures F of the different sub-pixel electrode portions P0 coincide with each other.

In a possible implementation, the block structures F of the different sub-pixel electrode portions P0 within one sub-pixel electrode group P00 may also be structures separated from each other.

In a possible implementation, referring to FIGS. 11A-11D, the block structure F may have a shape that may be similar to the shape of the first hollow portion L1, e.g., as shown in FIG. 11A, the shape of the first hollow portion L1 is a right-angled trapezoid, and the shape of the block structure F is a right-angled trapezoid as well. The block structure F may have a similar shape to the first hollow portion L1 and be provided in a different manner from it. For example, as shown in FIG. 11A, a bottom edge of the first hollow portion L1 partially coincides with a top edge of the block structure F, a top edge of the first hollow portion L1 partially coincides with a bottom edge of the block structure F, a right-angled edge of the first hollow portion L1 at least partially coincides with a right-angled edge of the block structure F, and a hypotenuse of the first hollow portion L1 crosses a hypotenuse of the block structure F, for example, the hypotenuse of the first hollow portion L1 is perpendicular to the hypotenuse of the block structure F.

For example, referring to FIG. 11A, the block structure F is a right-angled trapezoid, an orthographic projection of a region where an acute angle corresponding to the long bottom edge of the block structure F is located on the array substrate 1 is not overlapped with the orthographic projection of the first hollow portion L1 on the array substrate 1; and an orthographic projection of a region where a right angle corresponding to the long bottom edge of the block structure F is located on the array substrate 1 is at least partially overlapped with the orthographic projection of the first hollow portion L1 on the array substrate 1.

In a possible implementation, referring to FIGS. 6A-6D, the block structure F may have a shape that may be different from that of the first hollow portion L1, for example, as shown in FIG. 6A, the first hollow portion L1 is shaped as a rectangle, and the block structure F is shaped as a triangle. The shape of the block structure F may be a right triangle. As shown in FIG. 6A, at least one right-angled edge of the block structure F of the right-angled triangle coincides with at least one edge of the first hollow portion L1 of the rectangle; and a hypotenuse of the block structure F of the right-angled triangle coincides with a diagonal line of the first hollow portion L1 of the rectangle.

In conjunction with FIG. 2J, FIG. 3C, FIG. 4C, FIG. 5C, FIG. 6D, FIG. 7C, FIG. 8C, FIG. 9C, FIG. 10C, and FIG. 11D, when the first hollow portion L1 is in the shape of a circular arc, the liquid crystals has a region of a haphazard arrangement, and an irregular dark pattern will appear; and when the edges of the first hollow portion L1 are parallel to the extension direction of the slit structures S, the dark pattern will be aggravated, and the transmittance rate will be reduced, as illustrated in FIGS. 2J and 7C. Among the above figures, the transmittance rates of FIG. 8C, FIG. 9C, and FIG. 10C are better.

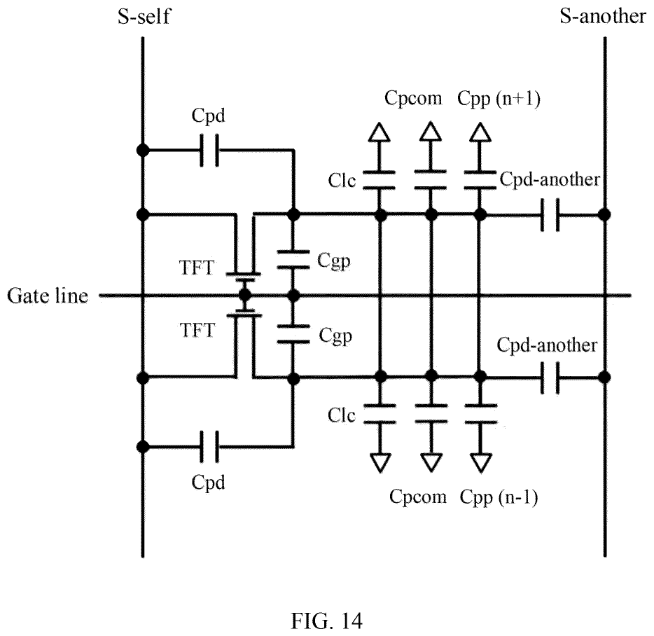

As shown in FIG. 14, an equivalent circuit diagram corresponding to a pixel electrode is provided for embodiments of the present disclosure, where S-self is a data line on the left side of the pixel, i.e., a signal line that transmits data signals for the current pixel electrode 15, i.e., a data line that electrically connects to the current pixel electrode 14, or S-another is a data line on the right side of the pixel, or a data line of the transverse adjacent pixels. The pixel circuit may include: transistors, and sub-pixel electrode groups on respective sides of the gate line may correspondingly form a first capacitance Cpd, a second capacitance Cgp, a liquid crystal capacitance Clc, a third capacitance Cpd-another, and a fourth capacitance Cpcom; where the first capacitance Cpd may be formed at an overlapping region of the pixel electrode 14 with the data line 15, the second capacitance Cgp may be formed at an overlapping region of the pixel electrode 14 with the gate line 16, the liquid crystal capacitance Clc may be formed by the pixel electrode 14 and the common electrode 22, the third capacitance Cpd-another may be formed between the pixel electrode 14 and the data line 15 adjacent thereto, and the fourth capacitance Cpcom may be formed between the pixel electrode 14 and the first electrode 12. Furthermore, Cpp(n+1) may be formed between a first sub-pixel electrode portion P1 of the current pixel electrode 14 and a first sub-pixel electrode portion P4 of the previous pixel electrode 14, and Cpp(n−1) may be formed between a fourth sub-pixel electrode portion P4 of the current pixel electrode 14 and a first sub-pixel electrode portion P1 of the next pixel electrode 14. The location at which the first hollow portion L1 is provided (i.e., the region of the first electrode 12 that is gouged out) is bright, which is equivalent to the absence of Cpcom, while the location at which no first hollow portion L1 is provided is dark, which is equivalent to the presence of Cpcom.

Based on the same inventive concept, embodiments of the present disclosure also provide a display device including the above-described display panel provided by embodiments of the present disclosure. The implementation of this display device can be found in the above embodiments of the display panel, and the repetition will not be repeated.

In specific implementation, in the embodiments of the present disclosure, the display device may be: a cellular phone, a tablet computer, a television set, a monitor, a laptop computer, a digital photo frame, a navigator, and any other product or component having a display function. Other essential components of the display device should be understood by those of ordinary skill in the art, and are not described herein, nor should they be taken as limitations on the present disclosure.

Although preferred embodiments of the present disclosure have been described, additional changes and modifications may be made to these embodiments once the basic inventive concepts are known to one of skill in the art. Therefore, the appended claims are intended to be construed to include the preferred embodiments as well as all changes and modifications that fall within the scope of the present disclosure.

Obviously, those skilled in the art can make various changes and variations to the present disclosure without departing from the spirit and scope of the present disclosure. Thus, to the extent that such modifications and variations of the present disclosure fall within the scope of the present claims and their technical equivalents, the present disclosure is intended to encompass such modifications and variations.

1.-34. (canceled)

35. A display panel, comprising:
an array substrate and an opposite substrate arranged opposite to each other;
a plurality of data lines, located in the array substrate, and extending along a first direction;
a plurality of pixel electrodes, located in the array substrate, wherein at least one pixel electrode of the plurality of pixel electrodes comprises a plurality of sub-pixel electrode portions arranged along the first direction;
a first electrode, located in the array substrate, wherein the first electrode comprises a plurality of first hollow portions, an orthographic projection of the first hollow portions on the array substrate is within an orthographic projection of the sub-pixel electrode portions on the array substrate; and
a common electrode, located in the opposite substrate.

36. The display panel according to claim 35, wherein the first electrode is on a side of the pixel electrode facing away from the opposite substrate.

37. The display panel according to claim 35, wherein the plurality of sub-pixel electrode portions comprises: two sub-pixel electrode groups distributed along the first direction, the sub-pixel electrode group comprises two of the sub-pixel electrode portions, the sub-pixel electrode portion is provided with a plurality of slit structures extending along a same direction, and the slit structures of the two sub-pixel electrode portions which are adjacent to each other and are comprised in the sub-pixel electrode group extend in different directions.

38. The display panel according to claim 37, wherein an axis line extending along a direction perpendicular to the first direction is between two sub-pixel electrode portions of one sub-pixel electrode group; and
two first hollow portions corresponding to the one sub-pixel electrode group are symmetrical with respect to the axis line.

39. The display panel according to claim 38, wherein a region of a center of an orthographic projection of the first hollow portion on the array substrate coincides with a region of a center of an orthographic projection of the sub-pixel electrode portion on the array substrate.

40. The display panel according to claim 39, wherein the orthographic projection of the first hollow portion on the array substrate is a circle, an ellipse, a rectangle, a hexagon, or a right-angled trapezoid.

41. The display panel according to claim 40, wherein the first hollow portion comprises a first edge extending along the first direction; and
extension lines of the first edges of two first hollow portions corresponding to one sub-pixel electrode group coincide with each other; and/or
the extension line of at least one of the first edges of the first hollow portions corresponding to one of two sub-pixel electrode groups in one pixel electrode does not coincide with the extension line of at least one of the first edges of the first hollow portions corresponding to another of the two sub-pixel electrode groups in the one pixel electrode.

42. The display panel according to claim 40, wherein at least one edge of the hexagon is parallel to an extension direction of the slit structures of the sub-pixel electrode portion in which the hexagon is located; and/or
at least one edge of the hexagon is perpendicular to an extension direction of the slit structures of the sub-pixel electrode portion in which the hexagon is located.

43. The display panel according to claim 41, wherein a right-angled edge of the right-angled trapezoid extends along the first direction, and a hypotenuse of the right-angled trapezoid is perpendicular to the extension direction of the slit structures.

44. The display panel according to claim 41, wherein top edges of two first hollow portions of right-angled trapezoids corresponding to one sub-pixel electrode group are provided in close proximity to each other; or
bottom edges of two first hollow portions of right-angled trapezoids corresponding to one sub-pixel electrode group are provided in close proximity to each other.

45. The display panel according to claim 41, wherein extension lines of right-angled edges of two first hollow portions of right-angled trapezoids corresponding to one sub-pixel electrode group coincide with each other; or
an extension line of the right-angled edge of the first hollow portion of a trapezoid corresponding to one of two sub-pixel electrode groups in one pixel electrode does not coincide with an extension line of the right-angled edge of the first hollow portion of a trapezoid corresponding to another of the two sub-pixel electrode groups in the one pixel electrode.

46. The display panel according to claim 39, wherein the orthographic projection of the first hollow portion on the array substrate is an X-shape; wherein
the first hollow portion comprises: a first hollow sub-portion extending along a third direction, and a second hollow sub-portion extending along a fourth direction, and the first hollow sub-portion crosses the second hollow sub-portion; and
one of the first hollow sub-portion or the second hollow sub-portion extends in a direction parallel to an extension direction of the slit structures of the sub-pixel electrode portion in which the one of the first hollow sub-portion or the second hollow sub-portion is located, and another of the first hollow sub-portion or the second hollow sub-portion extends in a direction perpendicular to an extension direction of the slit structures of the sub-pixel electrode portion in which the another of the first hollow sub-portion or the second hollow sub-portion is located.

47. The display panel according to claim 35, wherein two first hollow portions corresponding to one sub-pixel electrode group are a one-piece structure; or
two first hollow portions corresponding to one sub-pixel electrode group are separated structures.

48. The display panel according to claim 37, wherein the slit structures are uniformly distributed throughout the sub-pixel electrode portion.

49. The display panel according to claim 37, wherein the slit structures are distributed in only a partial region of the sub-pixel electrode portion, and the sub-pixel electrode portion further comprises a block structure;
wherein the block structures in two sub-pixel electrode groups in one pixel electrode are distributed at different positions; and
the block structures in two sub-pixel electrode portions of one sub-pixel electrode group are a one-piece structure;
wherein an orthographic projection of the first hollow portion on the array substrate is at least partially overlapped with an orthographic projection of the block structure on the array substrate.

50. The display panel according to claim 37, wherein the plurality of sub-pixel electrode portions comprise: a first sub-pixel electrode portion, a second sub-pixel electrode portion, a third sub-pixel electrode portion, and a fourth sub-pixel electrode portion arranged sequentially along the first direction; wherein
an extension direction of the slit structures of the first sub-pixel electrode portion is the same as an extension direction of the slit structures of the third sub-pixel electrode portion, and an extension direction of the slit structures of the second sub-pixel electrode portion is the same as an extension direction of the slit structures of the fourth sub-pixel electrode portion.

51. The display panel according to claim 50, further comprising: a plurality of gate lines, located in the array substrate, and extending along a second direction; wherein
an orthographic projection of the gate line on the array substrate has an overlapping region with an orthographic projection of a gap between the second sub-pixel electrode portion and the third sub-pixel electrode portion on the array substrate.

52. The display panel according to claim 51, wherein the gate line comprises a first gate line hollow; wherein
an orthographic projection of the first gate line hollow on the array substrate is overlapped with an orthographic projection of a portion of the data line on the array substrate;
wherein the pixel electrode further comprises: a connection portion connecting the second sub-pixel electrode portion to the third sub-pixel electrode portion; and
the gate line further comprises a second gate line hollow, wherein an orthographic projection of the second gate line hollow on the array substrate is at least partially overlapped with an orthographic projection of the connection portion on the array substrate.

53. The display panel according to claim 52, wherein extension lines of the connection portions of two pixel electrodes which are adjacent to each other in the first direction do not coincide with each other.

54. A display device, comprising the display panel according to claim 35.
